(19) United States
(12) Patent Application Publication
(10) Pub. No.: US 2011/0023559 A1
(43) Pub. Date: Feb. 3, 2011

(54) DOOR HINGE FOR A HOUSEHOLD APPLIANCE DOOR

(75) Inventor: Oliver Schöne, New Bern, NC (US)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH HOME APPLIANCES CORPORATION, Huntington Beach, CA (US)

(21) Appl. No.: 12/512,343

(22) Filed: Jul. 30, 2009

(51) Int. Cl. D06F 37/00; E05D 5/02; D06F 39/12; A47B 96/00

(52) U.S. Cl. 68/212; 16/388; 312/228; 312/326

(57) ABSTRACT

A hinge for a door assembly of a household appliance, wherein the household appliance includes a housing having an opening for accessing an interior of the housing, a tub disposed inside the housing, the tub having a rotating drum, the door assembly having a see-through portion for viewing into the tub, the door assembly being pivotably coupled to the housing by the hinge and movable between an open and closed position. The hinge includes a hinge body configured to be mounted to a front panel of the housing, a pair of hinge arms extending from a front surface of the hinge body, a locating boss projecting from a rear surface of the hinge body, a pair of hooks extending from the rear surface of the hinge body, and a pair of screw points extending through the hinge body.

### CROSS-REFERENCES TO RELATED APPLICATIONS

This application is related to applicant's co-pending U.S. applications, which are filed concurrently herewith, titled “DOOR HOOK FOR A HOUSEHOLD APPLIANCE DOOR”, Attorney Docket No. 2009P01009US; “DOOR BOWL FOR A HOUSEHOLD APPLIANCE DOOR”, Attorney Docket No. 2009P01010US; “DOOR FRAME FOR A HOUSEHOLD APPLIANCE DOOR”, Attorney Docket No. 2009P02522US; “OVERMOLD SEAL AND RAMP FOR A HOUSEHOLD APPLIANCE DOOR”, Attorney Docket No. 2009P02523US; “INNER RING HAVING A FUNNEL ELEMENT FOR A HOUSEHOLD APPLIANCE DOOR”, Attorney Docket No. 2009P02524US; and “FRONT RING FOR A HOUSEHOLD APPLIANCE DOOR”, Attorney Docket No. 2009P02525US, each of which is incorporated herein by reference in its entirety.

### FIELD OF THE INVENTION

The present invention is directed toward a household appliance, and more particularly, a door of a household appliance having a see-through portion, and more particularly to a door hinge of a household appliance, and more particularly, to a universal door hinge for a washer and dryer.

### BACKGROUND OF THE INVENTION

Household appliances, such as clothes washers and dryers, generally include a door that covers an opening for accessing the interior of the appliance. Such clothes washers or dryers commonly include a housing, a rotating drum disposed within the housing, and a driver device for driving the rotating drum. In operation, the door of the appliance is opened and clothes or laundry are inserted into the washer or dryer through the opening and placed in the rotating drum and the door is then closed.

Front-load clothes washers and dryers, which have a door positioned on the front of the appliance, have become increasingly popular in recent years for household use. Such front-load washers and dryers commonly include glass or see-through portions in the door to allow an operator to monitor the laundry while it is in the rotating drum.

Such household appliances commonly are positioned side-by-side in a laundry room of a home. In the case of front-load washers and dryers, the door of each household appliance opens out from the front of the appliance. The location of the door hinge determines whether the door is a right-hand opening door or left-hand opening door. The location of water and drain hook-ups, or power outlets, commonly determines whether the dryer can be located on the right hand side or the left hand side of the washer.

In some cases, the proximity of the appliances to walls or doorways, other appliances, or furniture, etc. may affect the location of the appliances. In these cases, it may be desirable to change the swing of the appliance door from a right-hand swing to a left-hand swing, for example, to permit easy access to the appliance.

A dryer door commonly can be configured to be either a right hand door or a left hand door. The dryer door commonly can be configured by the user to open from either side. That is, the dryer door and latch commonly are removable by the user to change the door between a left-hand opening door and a right-hand opening door.

In contrast, the location of the door hinge on a washer door commonly is fixed such that the washer only has a single door configuration. That is, the washer door commonly opens only from one side and cannot be reconfigured by the user to open from a different side.

Commonly, a washer and dryer, which are produced by the same manufacturer and are part of the same model line, have a similar appearance from the outside, since such appliances are often purchased together and installed side-by-side. Despite their similar appearance from the exterior, some of the features, functions, or designs of the washer door can be different from many of those of the dryer door.

The number and type of parts, steps, time, and cost associated with manufacturing and installing the conventional washer door on a washer can be dramatically different from those of a dryer door, which may affect the efficiency, cost, and time of manufacturing a washer or dryer. Moreover, different manufacturing lines or stations may be needed to manufacture a washer door compared to a dryer door, which may affect the efficiency, cost, and time of manufacturing a washer or dryer.

In many conventional household appliances, the hinges for a washer or dryer are specialized. That is, a hinge that is used for a washer door is different from a hinge that is used for a dryer door. This commonly results in different stations being needed during the manufacturing process to install the difference hinges on the washer door or the dryer door. The cost of stocking the different hinges and corresponding parts may increase the manufacturing costs.

Moreover, in many conventional appliances, the hinge commonly is difficult to access without disassembling a portion of the door. Accordingly, in a case in which a user wishes to change the swing of an appliance door, such as a dryer door, the disassembly and re-assembly of the appliance door similarly can be difficult and time consuming, for example, since part of or all of the door may need to be disassembled and re-assembled in order to make such a change.

For example, in some conventional hinge designs, the screws for securing the hinge are located behind the door and can only be accessed without the door in place. This may result in an increase in the number of steps in both the assembly process (e.g., a pre-assembly step and a door assembly step) and the repair or disassembly process.

In some conventional hinge designs, the hinge includes a hinge plate having hooks on the back side of the hinge plate that engage into mating slots formed on the housing during a downward movement of the hinge plate. In this manner, the hinge plate protrudes from the surface of the housing. Thus, in these conventional hinge designs, the hinge is not flush with the adjacent surface of the housing, which may limit the compactness of the design, increase the susceptibility of the hinge area to collection of dirt and debris, and increase the difficulty of cleaning and maintaining the cleanliness of these areas.

### SUMMARY OF THE INVENTION

These problems and others are addressed by the present invention, a first exemplary embodiment of which comprises a hinge for a door assembly of a household appliance, wherein the household appliance includes a housing having an opening for accessing an interior of the housing, a tub disposed inside the housing, the tub having a rotating drum therein for receiving laundry through the opening, the door assembly having a see-through portion for viewing into the tub, the door assembly being pivotably coupled to the housing by the hinge and movable between an open position for accessing the opening of the housing and a closed position for closing the opening of the housing. The hinge includes a hinge body configured to be mounted to a front panel of the housing, a pair of hinge arms extending from a front surface of the hinge body, a locating boss projecting from a rear surface of the hinge body, a pair of hooks extending from the rear surface of the hinge body, and a pair of screw points extending through the hinge body.

Another exemplary embodiment of the invention comprises a household appliance including a housing having an opening for accessing an interior of the housing, a tub disposed inside the housing, the tub having a rotating drum therein for receiving laundry through the opening, and a door assembly having a see-through portion for viewing into the tub, the door assembly being pivotably coupled to the housing and movable between an open position for accessing the opening of the housing and a closed position for closing the opening of the housing. The door assembly includes a hinge that pivotably couples the door assembly to the housing. The hinge includes a hinge body configured to be mounted to a front panel of the housing, a pair of hinge arms extending from a front surface of the hinge body, a locating boss projecting from a rear surface of the hinge body, a pair of hooks extending from the rear surface of the hinge body, and a pair of screw points extending through the hinge body.

Another exemplary embodiment of the invention comprises a household appliance including a door assembly of a household appliance, wherein the household appliance includes a housing having an opening for accessing an interior of the housing, a tub disposed inside the housing, the tub having a rotating drum therein for receiving laundry through the opening, the door assembly having a see-through portion for viewing into the tub, the door assembly being pivotably coupled to the housing and movable between an open position for accessing the opening of the housing and a closed position for closing the opening of the housing. The door assembly comprises a hinge that pivotably couples the door assembly to the housing. The hinge includes a hinge body configured to be mounted to a front panel of the housing, a pair of hinge arms extending from a front surface of the hinge body, a locating boss projecting from a rear surface of the hinge body, a pair of hooks extending from the rear surface of the hinge body, and a pair of screw points extending through the hinge body.

The exemplary embodiments of the present invention provide a universal hinge for both a washer door and a dryer door.

An exemplary embodiment of the present invention provides a hinge having a lean design that can be mounted flush with the front panel of the housing.

Another exemplary embodiment of the hinge can be simply and easily inserted in a horizontal direction into a controlled cutout and stamping on the front panel of the housing and rotated into a flush position on the housing, thereby simplifying the assembly process, reducing time and labor costs, and reducing overall manufacturing costs.

An exemplary embodiment of the hinge can include a locating boss to ensure proper and accurate alignment of the hinge in the cutout of the front panel of the housing.

Another exemplary embodiment of the hinge can include a hinge body having a curved edge that corresponds to a shape of a cutout or stamping on the housing of the washer or dryer such that the hinge can be installed only in a single configuration for a left-hand opening door and a single configuration for a right-hand opening door.

Other exemplary embodiments of the hinge can address the varying forces applied to the hinge during opening and closing of the washer door or dryer door. For example, the present invention recognizes that during operation of the hinge, a downward force may be applied to the door, for example, from the weight of the door itself or from abnormal operation of the door, such as a user leaning on the door or a child swinging from or hanging on the door. This downward force applies varying forces acting the hinge. For example, the downward forces exerted on the door may result in a downward force (i.e., push force) being applied to a lower hinge arm of the hinge by the hinge pocket, and an upward force (i.e., pull force) being applied to an upper hinge arm of the hinge by the hinge pocket, such that the hinge is subjected to a twisting force.

To address or solve these problems, an exemplary embodiment of the hinge can include a pair of hooks on a first side that are aligned with the hinge arms for addressing forces in a first horizontal direction, and a pair of screw points on a second side for addressing forces in a second horizontal direction. The pair of screws points can be configured to be spaced at far ends of the hinge body to spread out the force applied to the screw points, for example, as far as possible, thereby reducing or limiting deformation caused by the twisting forces (e.g., twisting or torque) induced by the door on the hinge.

Moreover, the exemplary embodiment may distribute the force applied to the screws over a larger area of the housing.

Another exemplary embodiment of the hinge can include hinge arms having an increased thickness, and more particularly, an increased thickness closer to the hinge body for increasing a stiffness of the hinge, thereby avoiding or reducing sagging over time as a result of the forces exerted on the hinge, for example, when the door is in the open position, in the event a user leans on the open door, etc.

In an exemplary embodiment of the hinge, the pair of screw points for securing the hinge to the housing of the washer or dryer that are offset such that the screw points can be easily accessed for attaching or removing the hinge from the housing of the washer or dryer irrespective of whether the hinge is assembled with the washer door or dryer door.

According to the exemplary embodiments of the invention, the hinge can be assembled with the washer door prior to installation on the housing of the washer. The hinge also can be easily removed from the housing of the washer, for example, for repairs or maintenance.

In the case of the dryer door, the hinge can be assembled with the door prior to installation on the housing of the dryer. Alternatively, the hinge can be assembled on the housing of the dryer prior to assembly with the dryer door. In an exemplary embodiment of the present invention, in a case in which a user wishes to change the swing of the dryer door, the disassembly and re-assembly of the appliance door can be easily and efficiently performed in a time effective manner by technicians or end-users, for example, since the entire door does not need to be disassembled and re-assembled in order to make such a change, and since the hinge is easily removed from the dryer housing with or without removing the hinge from the dryer door.

In another exemplary embodiment of the invention, the universal hinge can be captured in a hinge pocket formed in the door frame, for example, for a dryer door. The hinge can be secured in the hinge pocket using a hinge cover to facilitate easy assembly and disassembly by a user, thereby facilitating easy changing of the door from a left-hand swing door to a right-hand swing door, and vice versa

In another exemplary embodiment of the invention, the universal hinge can be captured in a hinge pocket formed between cooperating features of an inner ring and a door frame of the door assembly, for example, for a washer door. In this manner, the present invention transfers or distributes the forces acting on the hinge over two parts of the door assembly, which act as one, thereby providing a robust door assembly design.

The exemplary embodiments provide a compact, clean, and elegant hinge design while also providing robust features for addressing a variety of forces exerted on the hinge during operation of the washer door or dryer door.

Other features and advantages of the present invention will become apparent to those skilled in the art upon review of the following detailed description and drawings.

### BRIEF DESCRIPTION OF THE DRAWINGS

These and other exemplary aspects and features of embodiments of the present invention will be better understood after a reading of the following detailed description, together with the attached drawings, wherein:

FIG. 1 illustrates a front view of a household appliance, according to an embodiment of the present invention;

FIG. 2 illustrates a front view of another household appliance according to an embodiment of the present invention;

FIG. 3A illustrates an exploded, front perspective view of the door of FIG. 1;

FIG. 3B illustrates an exploded, rear perspective view of the door of FIG. 1;

FIG. 3C illustrates a rear perspective view of the assembled door of FIG. 1;

FIG. 3D illustrates a top down view of the assembled door of FIG. 1;

FIG. 3E illustrates a side view of the assembled door of FIG. 1;

FIG. 4A illustrates an exploded, front perspective view of the door of FIG. 2;

FIG. 4B illustrates an exploded, rear perspective view of the door of FIG. 2;

FIG. 5A illustrates a front view of a front ring of a door according to an embodiment of the invention;

FIG. 5B illustrates a side view of a front ring of a door according to an embodiment of the invention;

FIG. 5C illustrates a rear view of a front ring of a door according to an embodiment of the invention;

FIG. 6A illustrates a front view of a plastic panel of a door according to an embodiment of the invention;

FIG. 6B illustrates a front perspective view of a plastic panel of a door according to an embodiment of the invention;

FIG. 6C illustrates a rear view of a plastic panel of a door according to an embodiment of the invention;

FIG. 7A illustrates a front view of the inner ring of the door of FIGS. 3A, 3B;

FIG. 7B illustrates a side view of the inner ring of the door of FIGS. 3A, 3B;

FIG. 7C illustrates a rear view of the inner ring of the door of FIGS. 3A, 3B;

FIG. 8A illustrates a front view of the inner ring of the door of FIGS. 4A, 4B;

FIG. 8B illustrates a rear view of the inner ring of the door of FIGS. 4A, 4B;

FIG. 8C illustrates a side view of the inner ring of the door of FIGS. 4A, 4B;

FIG. 8D illustrates a front perspective view of the inner ring of the door of FIGS. 4A, 4B;

FIG. 8E illustrates a rear perspective view of the inner ring of the door of FIGS. 4A, 4B;

FIG. 9A illustrates a front view of the door frame of the door of FIGS. 3A, 3B;

FIG. 9B illustrates a side view of the door frame of the door of FIGS. 3A, 3B;

FIG. 9C illustrates a rear view of the door frame of the door of FIGS. 3A, 3B;

FIG. 10A illustrates a perspective front view of the door frame of the door of FIGS. 4A, 4B;

FIG. 10B illustrates a perspective rear view of the door frame of the door of FIGS. 4A, 4B;

FIG. 10C illustrates an exploded, partial perspective rear view of the door frame of the door of FIGS. 4A, 4B;

FIG. 10D illustrates an assembled partial perspective rear view of the door frame of the door of FIGS. 4A, 4B;

FIG. 10E illustrates a partial cross-sectional side view of the door frame of the door of FIGS. 4A, 4B;

FIG. 10F illustrates a partial cross-sectional perspective view of the door frame of the door of FIGS. 4A, 4B;

FIG. 11A illustrates a perspective rear view of the assembled door of FIGS. 4A, 4B;

FIG. 11B illustrates a partial exploded, perspective rear view of the door of FIGS. 4A, 4B;

FIG. 12 illustrates a striker cover assembly according to an embodiment of the invention;

FIG. 13A illustrates another perspective rear view of the assembled door of FIGS. 4A, 4B;

FIG. 13B illustrates a partial cross-sectional side view of the assembled door of FIGS. 4A, 4B;

FIG. 13C illustrates a partial perspective front view of the door of FIGS. 4A, 4B;

FIG. 14A illustrates a front perspective view of a hinge according to an embodiment of the invention;

FIG. 14B illustrates a rear perspective view of a hinge according to an embodiment of the invention;

FIG. 14C illustrates a top view of a hinge according to an embodiment of the invention;

FIG. 14D illustrates a front plan view of a hinge according to an embodiment of the invention;

FIG. 14E illustrates a side plan view of a hinge according to an embodiment of the invention;

FIG. 14F illustrates a rear plan view of a hinge according to an embodiment of the invention;

FIG. 14G illustrates a cross-sectional view taken along section A-A of FIG. 14D;

FIG. 14H illustrates a cross-sectional view taken along section B-B of FIG. 14E;

FIG. 14I illustrates a front view of an assembly of a front panel of a housing and a hinge according to an embodiment of the invention;

FIG. 14J illustrates a rear view of an assembly of a front panel of a housing and a hinge according to an embodiment of the invention;

FIG. 14K illustrates a partial front perspective view of an assembly of a front panel of a housing and hinge according to an embodiment of the invention;

FIG. 14L illustrates a partial rear perspective cut-away view of an assembly of a front panel of a housing and hinge according to an embodiment of the invention; and

FIG. 14M illustrates a partial side perspective cut-away view of an assembly of a front panel of a housing and hinge according to an embodiment of the invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

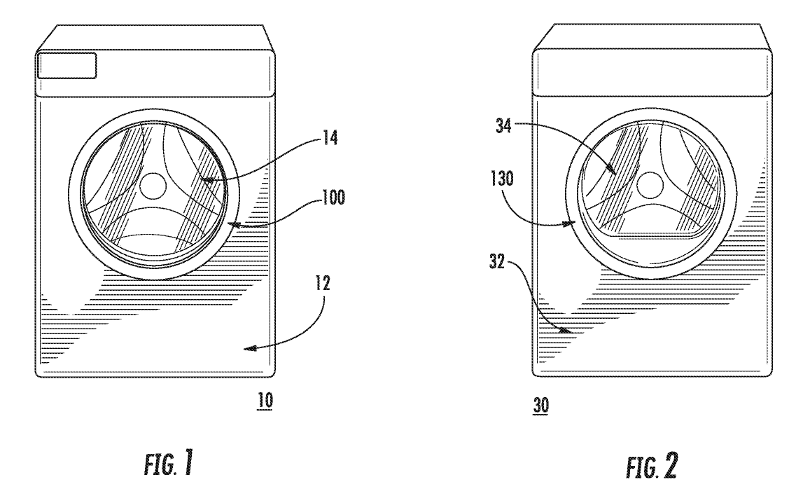

Referring now to the drawings, FIGS. 1-14M illustrate exemplary embodiments of a household appliance.

FIG. 1 illustrates a household appliance 10, for example, a washer, having a housing 12 and a door 100 connected to the housing 12. The door 100 is mounted with a hinge to pivot with respect to the housing 12 between an open condition and a closed condition. FIG. 1 shows the door 100 in the closed condition. A rotating drum (not illustrated) and a drive device (not illustrated) for driving the rotating drum are disposed within the housing 12. The rotating drum receives clothes or laundry items for washing the items. FIG. 1 illustrates the door 100 on a horizontal axis washer 10.

The washer 10 can include an opening for accessing the rotating drum in the interior of the housing 12. The housing 12 of the washer 10 can have a hinge mounting surface configured to receive a hinge for pivoting the door 100 with respect to the washer 10. The hinge 500 and door 100 will be described in more detail below. The hinge mounting surface can be located along the perimeter of the opening. The housing 12 can include a support surface or stamping that receives a door hook receptacle. The door hook receptacle can be configured to engage a door hook of the door 100 for retaining the door 100 in a closed position.

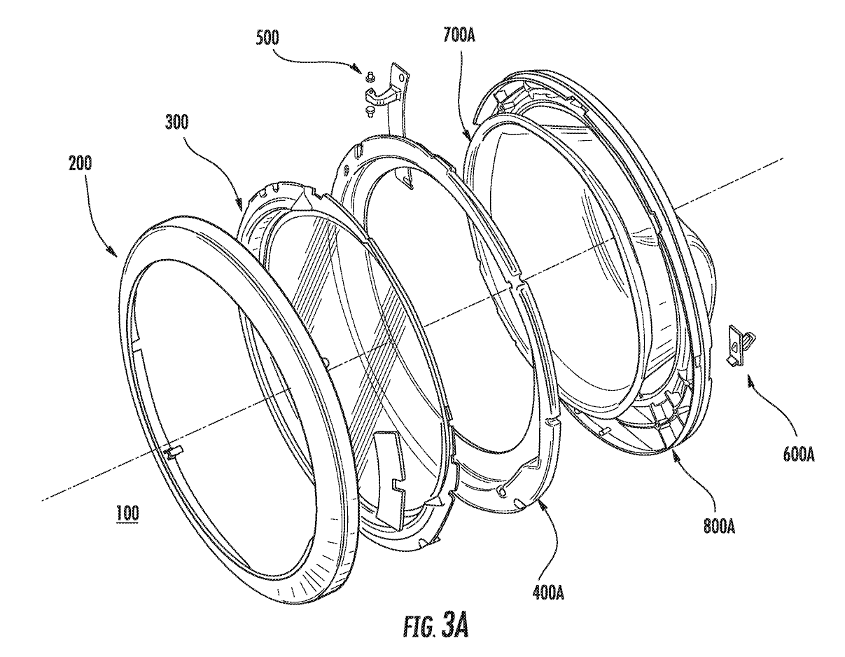

FIG. 2 illustrates a household appliance 30, for example, a dryer, having a housing 32 and a door 130 connected to the housing 32. The door 130 is mounted with a hinge to pivot with respect to the housing 32 between an open condition and a closed condition. FIG. 2 shows the door 130 in the closed condition. A rotating drum (not illustrated) and a drive device (not illustrated) for driving the rotating drum are disposed within the housing 32. The rotating drum receives clothes or laundry items for drying the items. The dryer 30 also can include a heating unit (not illustrated), such as a gas heating unit or an electric heating unit, disposed within the housing 32 for applying heat to the laundry within the rotating drum. FIG. 2 illustrates the door 130 on a horizontal axis dryer 30. The door 130 having the see-through portion 34 also can be used with a dryer having a vertical axis, or with a dryer having either a horizontal or vertical axis.

The dryer 30 can include an opening for accessing the rotating drum in the interior of the housing 32. The housing 32 of the dryer 30 can have one or more hinge mounting surfaces or stampings 38 configured to receive a hinge for pivoting the door 130 with respect to the dryer 30. The hinge and door 130 will be described in more detail below. The hinge mounting surfaces can be located along the perimeter of the opening and at more than one location to facilitate changing the swing of the door 130 between a left-hand opening door and a right-hand opening door by the user. For example, the hinge mounting surfaces can be located on opposite sides of the opening.

The housing 32 can include one or more support surfaces or stampings that receive a door latch receptacle. The door latch receptacle can be configured to engage a door hook of the door 130 for retaining the door 130 in a closed position. The support surfaces can be located adjacent to or within the hinge mounting surfaces to facilitate changing the swing of the door 130 between a left-hand opening door and a right-hand opening door by the user.

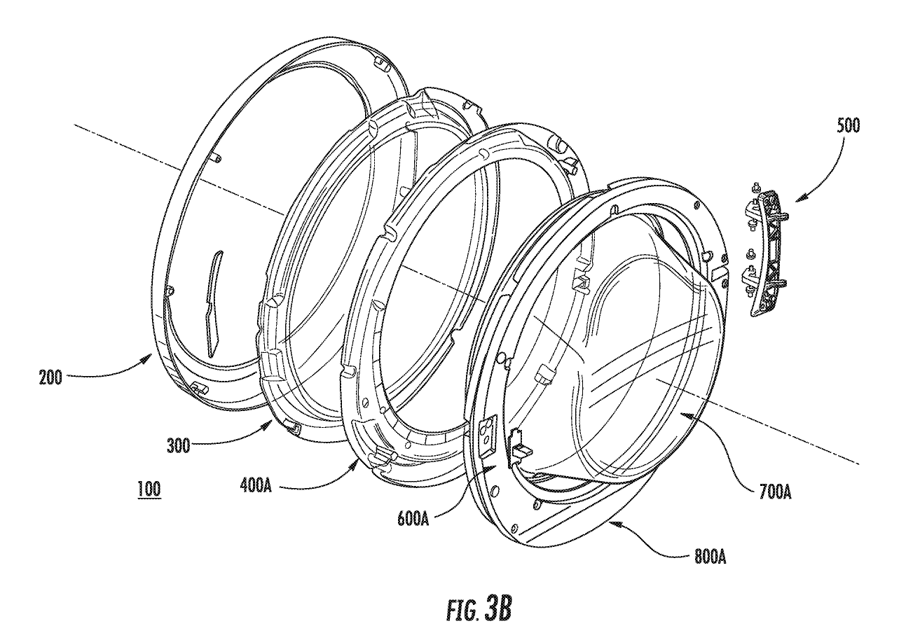

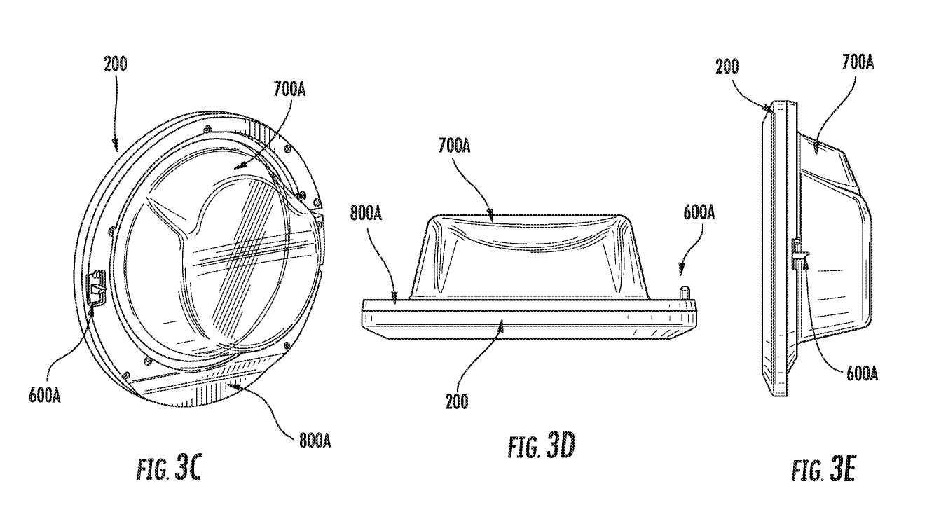

FIGS. 3A and 3B illustrate exploded assembly views of an exemplary arrangement of a washer door 100 of FIG. 1. The door 100 includes a front ring 200, a plastic cover panel 300, an inner ring 400A, a door hinge 500, a door hook or latch 600A, a glass bowl 700A, and a door frame 800A, among other features. The features of each of these components will be described in more detail below.

FIGS. 3C-3D illustrate an assembled washer door 100 of FIG. 1 having a front ring 200, a door frame 800A, a glass bowl 700B, and a door hook 600A.

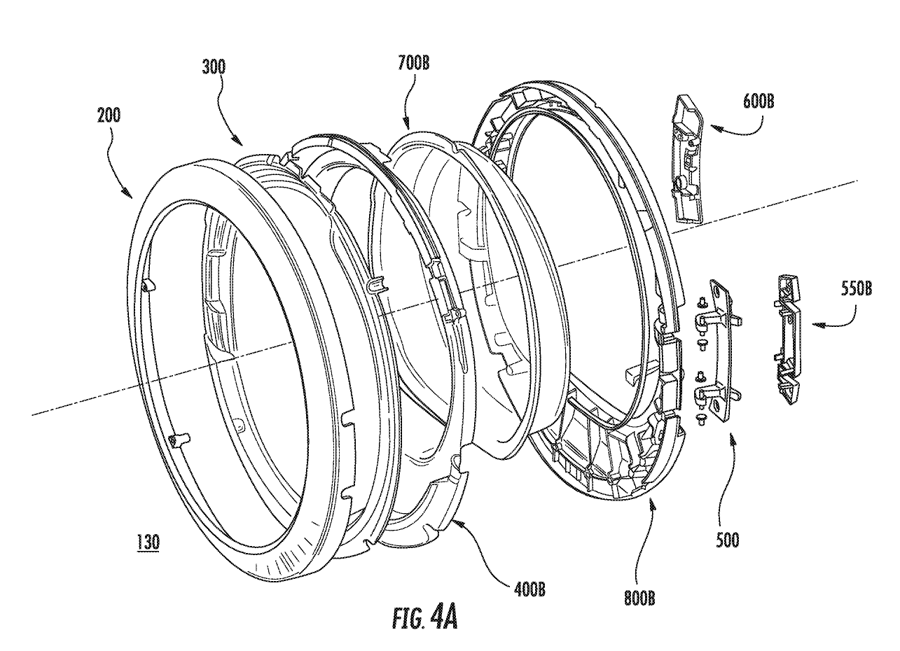

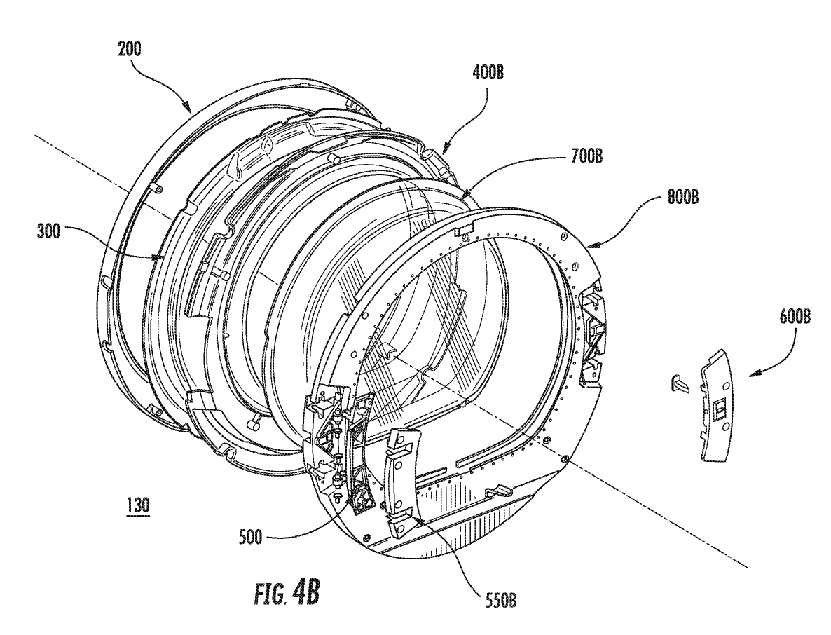

FIGS. 4A and 4B illustrate exploded assembly views of an exemplary arrangement of a dryer door 130 of FIG. 2. The door 130 includes the front ring 200, the plastic cover panel 300, an inner ring 400B, the door hinge 500, a door striker 600B, a glass bowl 700B, and a door frame 800B, among other features. The features of each of these components will be described in more detail below.

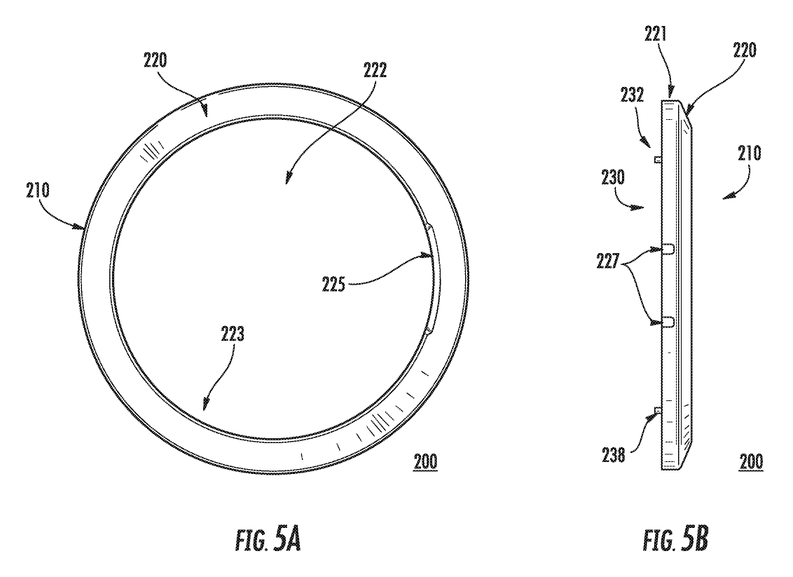

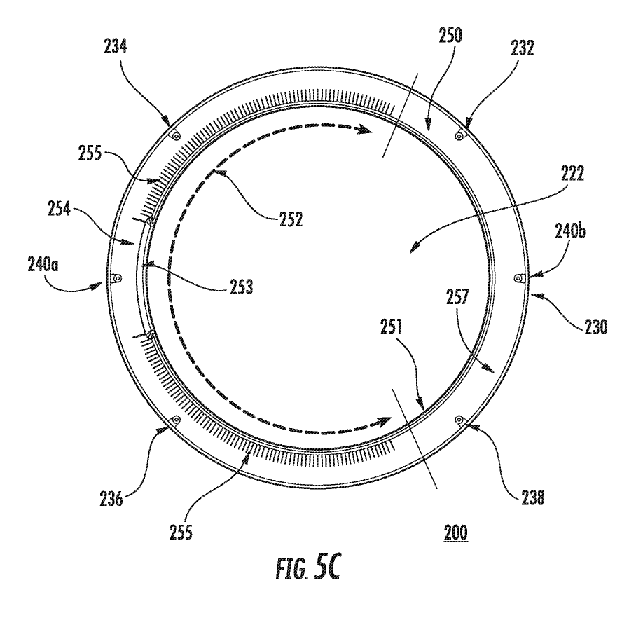

With reference to FIGS. 5A-5C, exemplary embodiments of a front ring 200 will now be described.

As shown in FIGS. 5A-5C, an exemplary embodiment of the front ring 200 can have a substantially circular shape when viewed from the front side 210. However, other shapes are contemplated within the spirit and scope of the invention.

In an exemplary embodiment, the front ring 200 can be configured to correspond to both the frame 400A of the washer 10 and the frame 400B of the dryer 30. That is, the front ring 200 can be configured to be universal or common to both a washer door 100 and a dryer door 130. The front ring 200 can include an opening 222 that corresponds to the see-through portion 14 of the washer door 100 and the dryer door 130. The opening 222 can have, for example, a circular or oval shape, as illustrated. However, in other exemplary embodiments, the opening can have other shapes. The opening 222 can be centered (e.g., concentric) within the front ring 200, or off-center. For example, in the exemplary embodiment illustrated, a center of the opening 222 is offset from, or above, a center of the front ring 200 such that a distance from the opening 222 to the outside edge of the front ring is greater at the bottom portion of the washer door 100 or the dryer door 130 than at the top portion of the washer door 100 or the dryer door 130.

The front ring 200 can be configured to work in conjunction with, or cooperate with, the plastic cover panel 300, which in turn can be configured to work in conjunction with, or cooperate with, the inner ring 400A or 400B. The plastic cover panel 300 and the inner ring 400A, 400B, as well as the relationship between these features and the front ring 200, will be described in more detail below.

As shown in FIGS. 5A and 5B, the front side 210 of the front ring 200 can include a face or surface 220, such as a beveled surface. The surface 220 can be, for example, colored, textured, smooth, or wrapped in metal, such as stainless steel, to provide a desired cosmetic appearance for the door assembly. The surface 220 can include a tapered edge 223 extending around a perimeter of the opening 222 and forming a lip 251 on the rear side of the front ring 220, as shown in FIG. 5C. The surface 220 also can include a tapered or beveled edge portion 225 corresponding to a location of a handle 254, for example, for visually or physically identifying the optimum handle location for opening and closing the door. The front ring 200 can include a side surface 221, extending in a direction of an axis of the opening 222. The side surface 221 can include hinge clearance features 227.

The rear side 230 can include a recessed rear face 250. The recessed rear face 250 can be bordered by an inner wall 257 of the side surface 221 and the lip 251, extending around the perimeter of the opening 222. The inner wall 257 can include a beveled or tapered surface 253 corresponding to the tapered or beveled edge portion 225.

The rear face 250 can include a handle portion 252 extending at least a portion of the way around the perimeter of the opening 222 of the front ring 200. As shown in FIGS. 5B, and 5C, the handle portion 252 can be symmetrical with respect to the front ring 200, and more particularly, with respect to the screw points 240a, and 240b, such that the front ring 200 can be universally used for either a right hand door or a left hand door. Also, the screw points 232, 234, 236, and 238 can be symmetrical.

In an exemplary embodiment, the handle portion 252 can include a grip portion 254. The grip portion 254 can include gripping means or a gripping feature 255, such as recessed grooves, finger grooves, elevated portions, bumps, or textures, or a separate piece that provides a gripping surface, such as a rubber surface, a textured surface, etc. The handle portion 252 can extend around at least a portion of the rear face 250. The handle portion 252 and/or the gripping feature 255 can be continuous or intermittent along the rear face 250. In this manner, the front ring 200 can be changed from a right-hand configuration to a left-hand configuration, for example for a dryer door 130, by rotating the front ring 200 by 180° in either direction.

The exemplary embodiments provide important advantages in that a user can open and close the door by grasping the front ring 200 at any location along the handle portion 252. The handle portion 252 provides a wide range for a user to grasp the door and apply force to open the door.

Additionally, the handle portion 252 is concealed from view behind the front ring 200. The concealed handle portion 252 provides a smooth exterior appearance that reduces the encroachment of the appliance into the space immediately in front of the appliance. In this manner, the front ring 200 can provide a user-friendly door handle that is less susceptible to dirt, fingerprints, etc. because the handle portion 252 is concealed. The front ring also can improve the aesthetic appearance of the appliance to the user.

The front ring 200 can be configured to work in conjunction with, or cooperate with, the plastic cover 300 and/or the inner ring 400A of the washer (or 400B of the dryer). The plastic cover 300 and/or the inner ring 400A (or 400B) can include a corresponding recessed portion or lip that corresponds to the handle portion 252 of the front ring 200 and provides clearance for gripping the handle portion 252 of the front ring 200. The recessed portion or lip of the plastic cover 300 and/or the inner ring 400A (or 400B) can extend at least a portion of the way around the perimeter of the door, and can include one or more indentions corresponding to the handle location(s) 254 of the front ring 200.

As shown in FIG. 5C, the rear side of the front ring 200 can include a plurality of fastener points, such as screw points (e.g., 232, 234, 236, 238, 240a, and 240b), spaced around the perimeter of the front ring 200 for securing the front ring 200 to other components of the door assembly.

In an exemplary embodiment, the front ring 200 can be secured to the door frame 800A (or 800B) using, for example, a plurality of screws inserted from the rear of the door assembly through corresponding openings or screw points in the door frame 800A (or 800B), then through clearance features or openings on the plastic cover panel 300 and the inner ring 400A (or 400B), and into the screw points 232, 234, 236, 238, 240a, and 240b.

The exemplary embodiments are not limited to assembly using screws. In other exemplary embodiments, these screw points can be other types of connection points, attachments, or receptacles for receiving fasteners such as screws, bolts, plastic fasters, or the like, or for mating with other fasteners.

In an exemplary embodiment, one or more screw points 240a, 240b can be provided at or near a location corresponding to a location of a door handle 254 to distribute or transfer the force applied at the handle location to the door frame 800A (or 800B).

Additionally, the screw points (e.g., 232, 234, 236, 240a, and 240b) can be configured such that the front ring 200 can only have a single orientation for assembly for a left-hand door and only a single orientation for assembly for a right-hand door, as shown in FIGS. 5B and 5C. For example, in the disclosed exemplary embodiment, the screw points 232, 234, 236, 238, 240a, and 240b are symmetrically arranged. In this manner, the front ring 200 can only be assembled in two possible orientations; one orientation for a right-hand door and one orientation for a left-hand door, thereby reducing assembly time and ensuring proper assembly. The right-hand door position is oriented 180 degrees from the left-hand door position. The correct orientation of the two possible orientations is easily selected during assembly based on the left-hand or right-hand hinge, since the hinge will obstruct the assembly if the front ring 200 orientation does not correspond to the hinge orientation.

As explained above, the front ring 200 can be universal to both the washer 10 and the dryer 30, thereby reducing manufacturing costs and complexity of the household appliances.

As explained above, the front ring 200 can be coupled to the door frame 800 at each of the screw points (e.g., 232, 234, 236, 238, 240a, and 240b). More particularly, the front ring 200 can be secured to the door frame 800A (or 800B) using, for example, a plurality of screws inserted from the rear of the door assembly through corresponding openings or screw points in the door frame 800A (or 800B), then through clearance features or openings on the plastic cover panel 300 and the inner ring 400A (or 400B), and into the screw points 232, 234, 236, 238, 240a, and 240b. The screw points (e.g., 232, 234, 236, 238, 240a, and 240b) can couple the front ring 200 to the door frame 800A (or 800B). In the illustrated exemplary embodiment, the front ring 200 can secure or press fit the plastic cover panel 300 between the front ring 200 and the inner ring 400A (or 400B), which can be coupled to the door frame 800A (or 800B) using separate attachment points.

In this manner, the front ring 200 is not necessary for assembly of the primary components of the door, which are needed for functional operation of the door. The front ring 200 can be removed or disassembled from the door frame 800A (or 800B) without affecting the functionality of the washer door 100 or the dryer door 130, respectively. The front ring 200 can be easily and efficiently removed and/or attached to simplify assembly, facilitate repairs, cosmetic changes, etc. without affecting the function of the washer door 100 or the dryer door 130. Moreover, in the illustrated exemplary embodiments, the front ring 200 can be easily and efficiently removed and/or attached to facilitate repair or replacement of the plastic cover panel 300, without affecting the function of the washer door 100 or the dryer door 130.

As explained above, the screw points 232, 234, 236, 238, 240a, and 240b support the front ring 200, or the front ring 200 and the plastic cover panel 300, and therefore, are not subjected to a large amount of forces. In contrast, the door frame 800A (or 800B) and the inner ring 400A (or 400B) are subjected to the weight of the glass bowl, etc.

In this manner, as shown in FIG. 5C, the screw points 232, 234, 236, 238, 240a, and 240b can be located at or near the outer edge of the front ring 200, which may be of lesser strength than an inner portion of the front ring 200. The corresponding screw points on the door frame 800A (or 800B) also can be located at or near the outer edge of the door frame 800A (or 800B).

By locating the screw points for securing the front ring to the door frame 800A (or 800B) at or near the edge of the door frame, the screw points for assembling the other components of the door, which may be subject to much higher forces, can be located in a more robust or higher strength portion of the door frame 800A (or 800B), such as at or near a center portion between the outer edge and the inner edge of the door frame 800A (or 800B).

Moreover, the accessibility of the screw points may be improved, thereby providing easy access to these screws for easily and efficiently attaching the front ring 200 to the door assembly after the door has been assembled, or after the assembled door has been installed on the appliance housing. Thus, the front ring 200 and/or the plastic cover panel 300 can be repaired or replaced with little effort.

The embodiments are not limited to the disclosed exemplary embodiments. In other exemplary embodiments, the front ring 200 can secure one or more of the plastic cover 300 to the door frame 800A (or 800B).

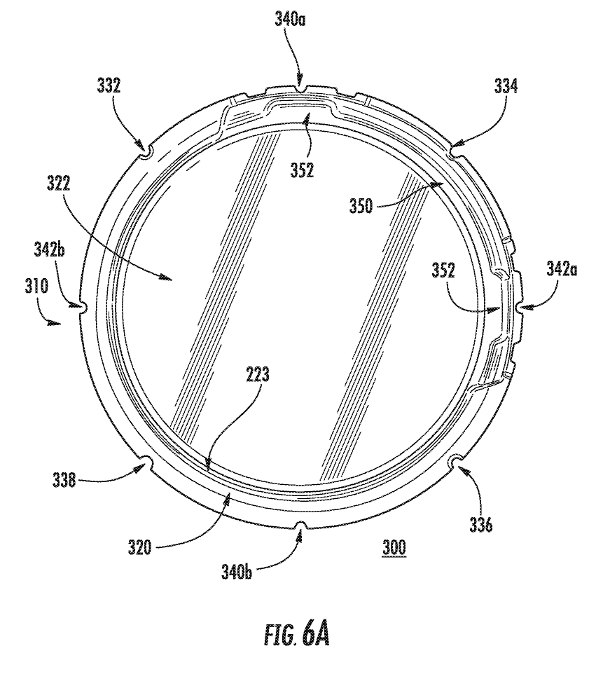

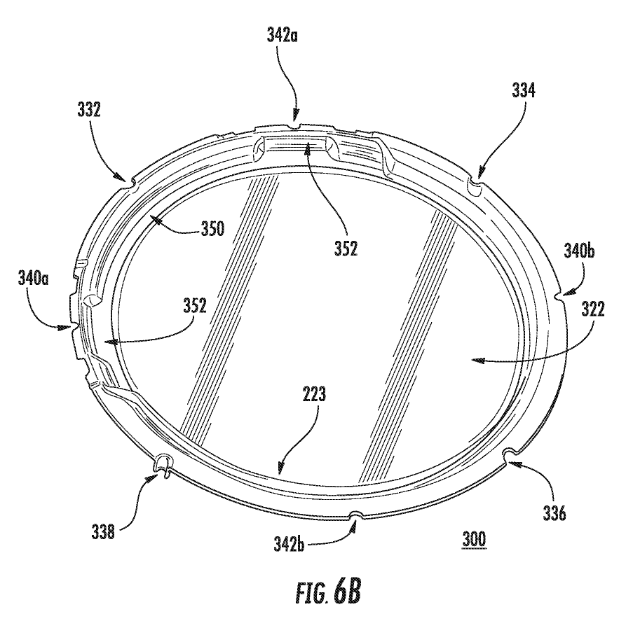

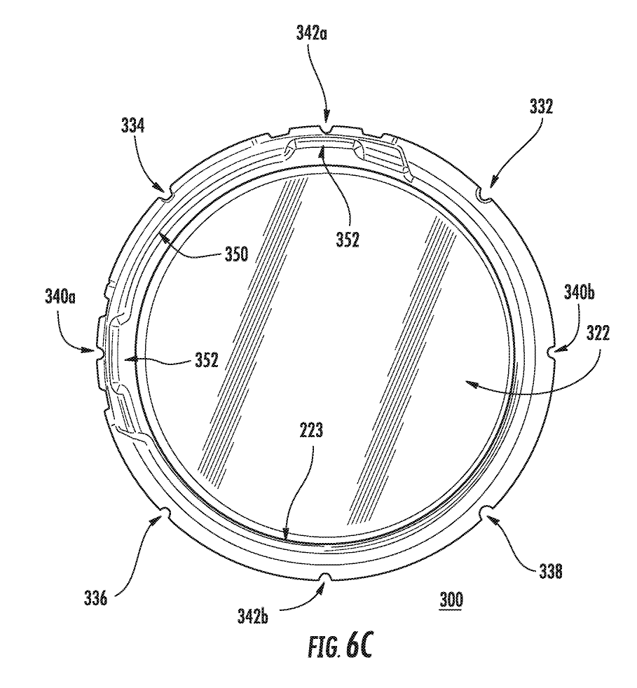

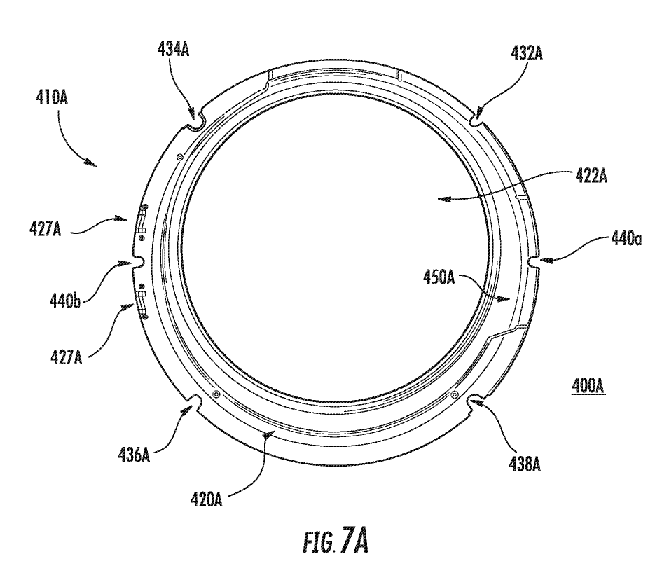

With reference to FIGS. 6A-6C, exemplary embodiments of a plastic cover panel 300 will now be described.

As shown in FIGS. 6A-6C, an exemplary embodiment of the plastic cover panel 300 can have a substantially circular shape when viewed from the front side 310. However, other shapes are contemplated within the spirit and scope of the invention.

In an exemplary embodiment, the plastic cover panel 300 can be configured to be universal or common to both a washer door 100 and a dryer door 130. The plastic cover panel 300 can include a see-through portion 322 that corresponds to the see-through portion 14 of the washer door 100 and the dryer door 130. In an exemplary embodiment, the plastic cover panel 300 is formed from a substantially transparent or translucent plastic.

FIGS. 6A and 6B illustrate an exemplary embodiment of the front side 310 of the plastic cover panel 300. FIG. 6C illustrates the plastic cover panel 300 from the rear side.

The plastic cover panel 300 can be configured to work in conjunction with, or cooperate with, the front ring 200 and the inner ring 400A (or 400B). The front side 310 can include a ring portion 320 extending around a perimeter of the see-through portion 322. In an exemplary embodiment, both the ring portion 320 and the see-through portion 322 are formed from a substantially transparent or translucent plastic.

The see-through portion 322 can have, for example, a circular or oval shape, as exemplarily illustrated. However, in other exemplary embodiments, the opening can have other shapes, such as a half-circle, half-oval, square, or rectangle shape, among other shapes. A center point of the see-through portion 222 can be concentric with a center point of the ring portion 320, or disposed off-center from the center point of the ring portion 320. For example, in the exemplary embodiment illustrated, a center of the see-through portion 322 can be offset from, or above, a center of the ring portion 320 such that a thickness of the ring portion 320 (i.e., a distance from the perimeter of the see-through portion 322 to the outside edge of the ring portion 320) is greater at the bottom portion of the washer door 100 or the dryer door 130 than at the top portion of the washer door 100 or the dryer door 130.

The ring portion 320 can include a recessed portion or lip 350 that corresponds to the grip or handle portion 252 of the front ring 200 and provides clearance for gripping the grip or handle portion 252 of the front ring 200. The recessed portion or lip 350 can extend at least a portion of the way around the perimeter of the ring portion 320 of the plastic cover panel 300. In an exemplary embodiment, the recessed portion or lip 350 can include one or more indentions 352 corresponding to one or more handle locations of the front ring 200.

As shown in FIGS. 6A and 6B, the plastic cover panel 300 can include a plurality of fastener points or pockets (e.g., locating features and/or clearance features) 332, 334, 336, and 338, that correspond to the locations of the screw points 232, 234, 236, and 238 of the front ring 200. The locating and/or clearance features 332, 334, 336, and 338 can correspond to similar features in the inner ring 400A (or 400B), as described in more detail below.

The locating and/or clearance features 332, 334, 336, and 338 can include, for example, an opening, notch, clearance feature, locating feature, protrusion, screw boss, partial screw boss, or the like that engages the corresponding feature of the inner ring 400A (or 400B) for aligning and positioning the plastic cover panel 300 in an assembled position. The locating and/or clearance features 332, 334, 336, and 338 can provide clearance for fasteners extending from the door frame 800A (or 800B) through clearance features of the inner ring 400A (or 400B) and into the screw points 232, 234, 236, and 238 of the front ring 200.

In an exemplary embodiment, the plastic cover panel 300 can include one or more locating and/or clearance features 340a, 340b, 342a, 342b that correspond to the location(s) of the screw points 240a, and 240b of the front ring 200, which are configured to correspond to a location of a door handle to distribute or transfer the force applied at the handle location to the door frame 800A (or 800B).

The locating and/or clearance features 340a, 340b, 342a, 342b can be symmetrical with respect to one of the locating and/or clearance features (e.g., 334) such that the plastic cover panel 300 can be universally used for either a right hand door or a left hand door.

The locating and/or clearance features 332, 334, 336, 338, 340a, 340b, 342a, 342b can be configured such that the plastic cover panel 300 can only have a single orientation for assembly for a heft-hand door and only a single orientation for assembly for a right-hand door. In an exemplary embodiment, the plastic cover panel 300 can be changed from a right-hand configuration to a left-hand configuration, for example for a dryer door 130, by rotating the plastic cover panel 300 by 90°. Depending on the position of the plastic cover panel 300 in the right-hand position or the left-hand position, one of the locating and clearance features 340a, 340b or 342a, 342b can correspond to the location of the screw points 240a, and 240b of the front ring 200, which can help to assure that the plastic cover panel 300 is correctly positioned for assembly.

In another exemplary embodiment, the size of one or more of the locating and/or clearance features 332, 334, 336, 338, 340a, 340b, 342a, 342b can be different from a size of the other clearance features such that the plastic cover panel 300 can only have a single orientation for assembly with the inner ring 400A (or 400B). Also, the inner shape of the cover glass can have a shape that matches or corresponds to a shape of the opening 222 of the inner ring.

In yet another exemplary embodiment, one or more of the locating and/or clearance features 332, 334, 336, 338, 340a, 340b, 342a, 342b can include an extension or protrusion configured that engages the corresponding locating and/or clearance feature of the inner ring 400A, 400B. In the illustrated exemplary embodiment, the locating and/or clearance features 334 and 338 have a protrusion. However, the embodiments are not limited to the illustrated exemplary embodiment and other configurations are possible within the spirit and scope of the invention.

As explained above, the plastic cover panel 300 can be universal to both the washer 10 and dryer 30 such that only a single station on the assembly line is needed for installing the front ring for both the washer 10 and dryer 30.

In an exemplary embodiment, the plastic cover panel 300 is disposed between the front ring 200 and the inner ring 400A (or 400B) when the washer door 100 or dryer door 130 is assembled. By securing the front ring 200 to the door frame 800A (or 800B), the plastic cover panel 300 is secured (e.g., press fit) between the front ring 200 and the inner ring 400A (or 400B). In these exemplary embodiments, the plastic cover panel 300 is not necessary for operation of the door assembly. The plastic cover panel 300 can be removed or disassembled from the door frame 800A (or 800B) by removing the front ring 200 without affecting the operation of the washer door 100 or the dryer door 130. According to these exemplary embodiments, the plastic cover panel 300 can be easily and efficiently removed and/or attached to facilitate repairs, cosmetic changes, etc. without affecting the function of the washer door 100 or the dryer door 130.

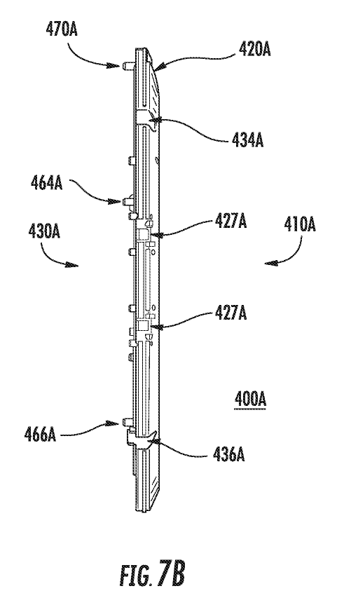

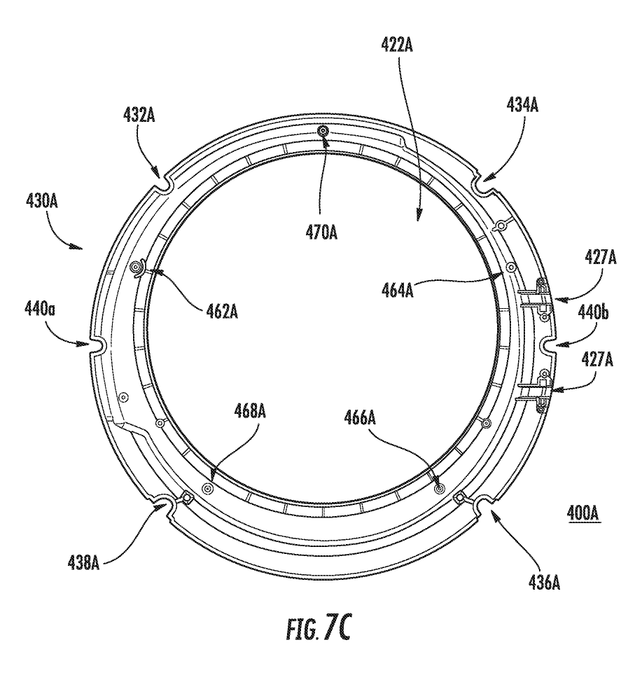

With reference to FIGS. 7A-7C, exemplary embodiments of an inner ring 400A, for example for a washer 10, will now be described.

As shown in FIGS. 7A-7C, an exemplary embodiment of the inner ring 400A can have a substantially circular shape when viewed from the front. However, other shapes are contemplated within the spirit and scope of the invention.

In an exemplary embodiment, the inner ring 400A can be configured to correspond to the front ring 200 and plastic cover or panel 300 of the washer 10 or dryer 30. In an exemplary embodiment, the inner ring 400A can be configured to have features that are particular to a washer door 100.

The inner ring 400A can include an opening 422A that corresponds to the see-through portion 14 of the washer door 100. The opening 422A can have, for example, a circular or oval shape, as illustrated. However, in other exemplary embodiments, the opening can have other shapes.

The opening 422A can be centered (e.g., concentric) within the inner ring 400A, or off-center. For example, in the exemplary embodiment illustrated, a center of the opening 422A is offset from, or above, a center of the inner ring 400A such that a distance from the opening 422A to the outside edge of the inner ring 400A is greater at the bottom portion of the washer door 100 than at the top portion of the washer door 100.

The door frame can be configured to work in conjunction with, or cooperate with, the plastic cover panel 300, which in turn can be configured to work in conjunction with, or cooperate with, the front ring 200.

FIG. 7A illustrates an exemplary embodiment of the front side 410A of the inner ring 400A. The inner ring 400A can include a ring portion 420A. The ring portion 420A can include a recessed portion or lip 450A that corresponds to the grip or handle portion 252 of the front ring 200 and the recessed portion or lip 350 of the plastic cover panel 300, which provide clearance for gripping the grip or handle portion 252 of the front ring 200. The recessed portion or lip 450A can extend at least a portion of the way around the perimeter of the ring portion 420A of the inner ring 400A.

As shown in FIGS. 7A and 7B, the inner ring 400A can include a plurality of locating and/or clearance features 432A, 434A, 436A, and 438A that correspond to the locations of locating and/or clearance features 332, 334, 336, and 338 of the plastic cover panel 300 and the screw points 232, 234, 236, and 238 of the front ring 200. The locating and/or clearance features 432A, 434A, 436A, and 438A can correspond to through holes and/or locating features 832A, 834A, 836A, and 838A of the door frame 800A, as described in more detail below.

The locating and/or clearance features 432A, 434A, 436A, and 438A can include, for example, an opening, notch, clearance feature, locating feature, protrusion, screw boss, partial screw boss, or the like that engages the corresponding feature of the door frame 800A for aligning and positioning the inner ring 400A in an assembled position. The locating and/or clearance features 432A, 434A, 436A, and 438A can provide clearance for fasteners extending from the door frame 800A such that the fasteners can extend through corresponding clearance features 332, 334, 336, and 338 of the plastic cover panel 300 and into the screw points 232, 234, 236, and 238 of the front ring 200.

In an exemplary embodiment, the inner ring 400A can include one or more locating and/or clearance features 440a, 440b that correspond to the location of clearance features 340a, 340b or 342a, 342b of the plastic cover panel 300 and the screw points 240a, and 240b of the front ring 200. These features are configured to correspond to a location of a door handle or grab handle to distribute or transfer the force applied at the handle location to the door frame 800A.

The locating and/or clearance features 432A, 434A, 436A, and 438A can be configured such that the inner ring 400A can only have a single orientation for assembly. For example, one or more of the locating and/or clearance features 432A, 434A, 436A, and 438A can have a size different from a size of the other clearance features, such that only a single orientation is possible. In this exemplary embodiment, the size of each clearance feature can correspond to a size of the locating and/or clearance features 332, 334, 336, 338, 340a, 340b, 342a, 342b of the front ring 200 and plastic cover 300. In other exemplary embodiments, the locating and/or clearance features can have a different shape, or a different size and shape, among other things.

In the illustrated exemplary embodiment, the locating and/or clearance features 434A and 438A can be larger than the other clearance features to accommodate both the locating features of the front ring 200 and the locating and/or clearance features 334 and 338 of the plastic cover 300, which can include an extension. The embodiments are not limited to the illustrated exemplary embodiment and other configurations are possible within the spirit and scope of the invention.

The inner ring 400A can include hinge pockets 427A for receiving a hinge 500, which will be described in more detail below. In an exemplary embodiment of the washer door 10, the hinge 500 can be secured or captured between the inner ring 400A and the washer frame 800A. In this manner, the inner ring 400A and the washer frame 800A act as a single part and the forces on the hinge 500 are transferred over both the inner ring 400A and the washer frame 800A.

The washer door 100 may not be configured to be disassembled by the end user. Hence, the inner ring 400A and the door frame 800A can be configured to have the hinge pockets 427A and 827A on a single side of the door, such that the washer door 100 can be configured to swing in only a single direction.

In an exemplary embodiment, the hinge pockets 427A can be 180° hinge pockets formed between the inner ring 400A and the washer frame 800A. The corresponding features of the inner ring 400A and the washer frame 800A can be conical shaped features that engage one inside the other.

With reference to FIG. 7B and 7C, the rear side 430A will now be described.

The inner ring 400A can include a plurality of fastener points, such as screw points 462A, 464A, 466A, 468A, and 470A, which correspond to the fastener points, e.g., screw points 862A, 864A, 866A, 868A, and 870A, of the door frame 800A, which will be described in more detail below. In this manner, the inner ring 400A and the door frame 800A can act as a single component to secure or capture the glass bowl 700A there between.

In an exemplary embodiment, the corresponding screw points of the inner ring 400A and the washer frame 800A can be conical shaped features that engage one inside the other.

In another exemplary embodiment, the screw points 462A, 464A, 466A, 468A, and 470A can be located around a perimeter of the opening 422A of the inner ring 400A. The screw points 462A, 464A, 466A, 468A, and 470A can be located closer to the opening 422A than to the outside edge of the inner ring 400A. In this manner, these screw points can be located proximate the rim of the glass bowl, thereby transferring and distributing the weight of, and the forces acting on, the glass bowl 700A to the inner ring 400A and the door frame 800A. Additionally, the screw points can be located in a more robust portion of the respective inner ring 400A and door frame 800A than the screw points for the front ring 200.

As explained above, the disclosed exemplary embodiments have a plurality of screw points (e.g., 462A, 464A, 466A, 468A, and 470A). However, in other exemplary embodiments, these screw points can be other types of connection points, attachments, or receptacles for receiving fasteners such as screws, bolts, plastic fasters, or the like, or for mating with other fasteners.

The hinge pockets 427A are configured to receiving a hinge 500, which will be described in more detail below. In an exemplary embodiment of the washer door 10, the hinge 500 can be secured between the inner ring 400A and the washer frame 800A.

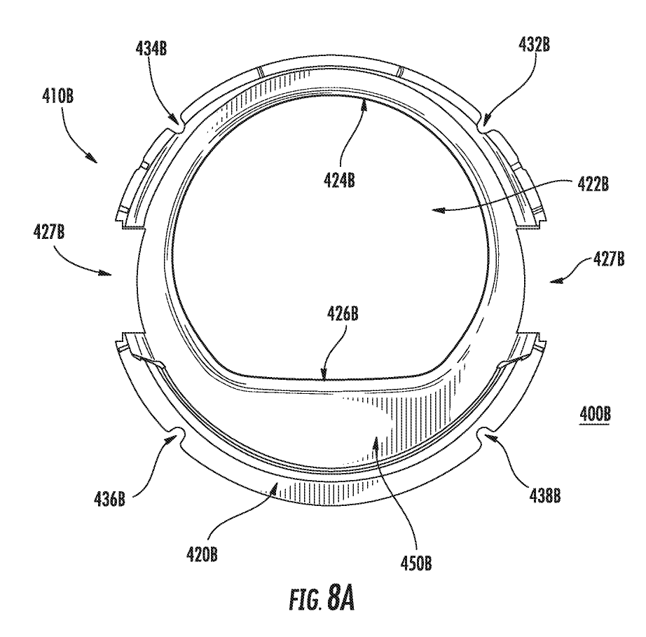

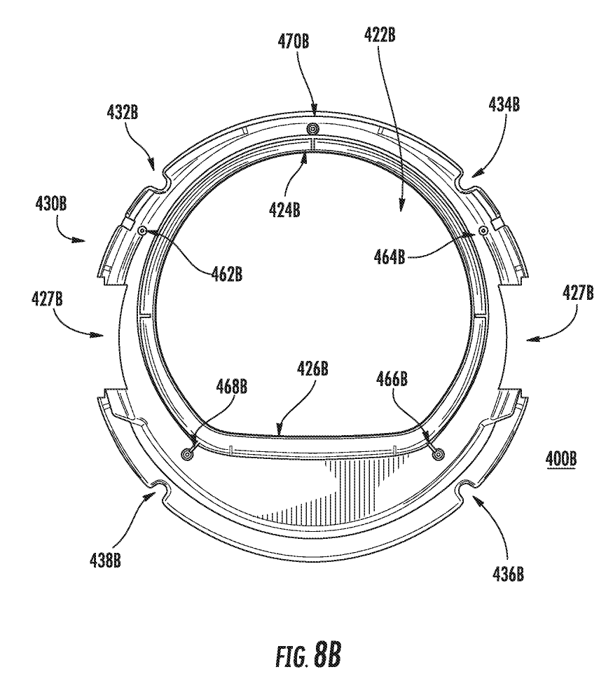

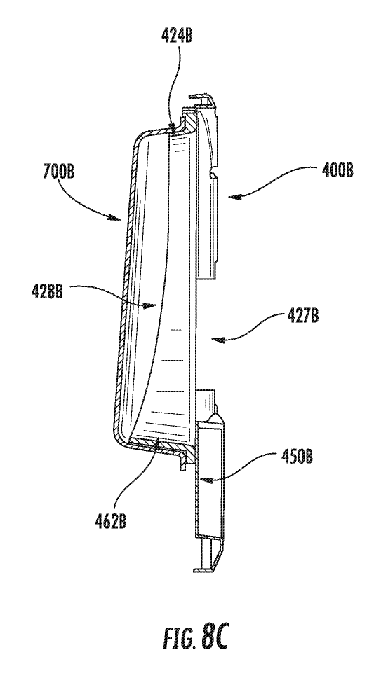

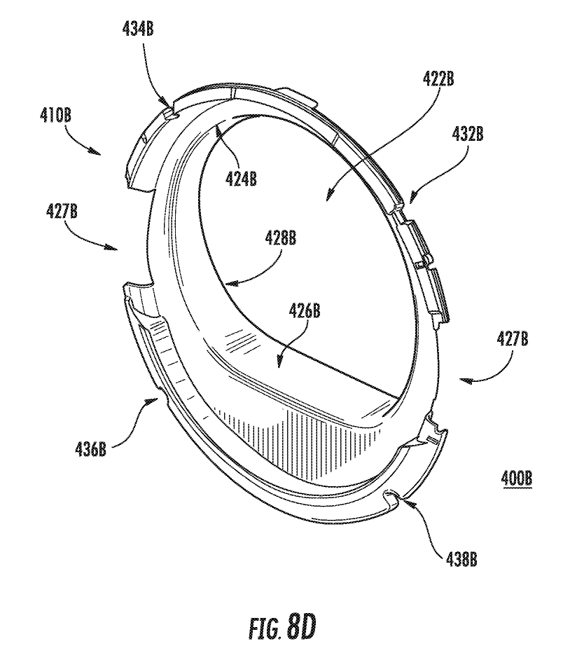

With reference to FIGS. 8A-8E, exemplary embodiments of an inner ring 400B, for example for a dryer 30, will now be described.

As shown in FIGS. 8A-8E, an exemplary embodiment of the inner ring 400B can have a substantially circular shape when viewed from the front. However, other shapes are contemplated within the spirit and scope of the invention.

In an exemplary embodiment, the inner ring 400B can be configured to correspond to the front ring 200 and plastic cover or panel 300 of the washer 10 or dryer 30. In an exemplary embodiment, the inner ring 400 can be configured to have features that are particular to a washer door 100.

The inner ring 400B can include an opening 422B that corresponds to the see-through portion 14 of the dryer door 130. The opening 422B can be centered (e.g., concentric) within the inner ring 400B, or off-center. For example, in the exemplary embodiment illustrated, a center of the opening 422B is offset from, or above, a center of the inner ring 400B such that a distance from the opening 422B to the outside edge of the inner ring 400B is greater at the bottom portion of the dryer door 130 than at the top portion of the dryer door 130. The inner ring 400B can be configured to work in conjunction with, or cooperate with, the plastic cover panel 300, which in turn can be configured to work in conjunction with, or cooperate with, the front ring 200.

The opening 422B can have, for example, a substantially circular or oval shape that corresponds to the shape of a glass bowl 700B for the dryer 30. In the illustrated exemplary embodiment, an upper portion of the opening 422B can have a substantially circular or oval shape and a lower portion of the opening 422B can have a cut-off section or a substantially parallel section that corresponds to the shape of the lower portion of the glass bowl 700B, as shown in FIG. 8C.

FIG. 8A illustrates an exemplary embodiment of the front side 410B of the inner ring 400B. The inner ring 400B can include a ring portion 422B. The ring portion 420B can include a recessed portion or face 450B.

As shown in FIGS. 8A and 8B, the inner ring 400B can include a plurality of locating and/or clearance features 432B, 434B, 436B, and 438B that correspond to the locations of locating and/or clearance features 332, 334, 336, and 338 of the plastic cover panel 300 and the screw points 232, 234, 236, and 238 of the front ring 200. The locating and/or clearance features 432B, 434B, 436B, and 438B can correspond to through holes and/or locating features 832B, 834B, 836B, and 838B of the door frame 800B, as described in more detail below.

The locating and/or clearance features 432B, 434B, 436B, and 438B can include, for example, an opening, notch, clearance feature, locating feature, protrusion, screw boss, partial screw boss, or the like (e.g., 862B, 864B, 866B, 868B) that engages the corresponding feature of the inner ring 400B for aligning and positioning the inner ring 400B in an assembled position. The locating and/or clearance features 432B, 434B, 436B, and 438B can provide clearance for fasteners extending from the door frame 800B such that the fasteners can extend through clearance features 332, 334, 336, and 338 of the plastic cover panel 300 and into the screw points 232, 234, 236, and 238 of the front ring 200.

The locating and/or clearance features 432B, 434B, 436B, 438B, and 440a, 440b can be configured such that the inner ring 400B can only have a single orientation for assembly. For example, one or more of the locating and/or clearance features 432B, 434B, 436B, and 438B can have a size different from a size of the other clearance features, such that only a single orientation is possible. In this exemplary embodiment, the size of each clearance feature can correspond to a size of the locating and/or clearance features 332, 334, 336, 338, 340a, 340b, 342a, 342b of the front ring 200 and plastic cover 300. In other exemplary embodiments, the locating and/or clearance features can have a different shape, or a different size and shape, among other things.

In the illustrated exemplary embodiment, the locating and/or clearance features 434B and 438B can be larger than the other clearance features to accommodate both the locating features of the front ring 200 and the locating and/or clearance features 334 and 338 of the plastic cover 300, which can include an extension. The embodiments are not limited to the illustrated exemplary embodiment and other configurations are possible within the spirit and scope of the invention.

In an exemplary embodiment, the inner ring 400B can include clearance features 427B that correspond to the location of the door hinge 500 and door striker 600B of the dryer door 130. The clearance features 440a, 440b can be provided on opposite sides of the inner ring 400B to facilitate changing of the door swing from a right-hand swing door to a left-hand swing door by the user.

The dryer door 130 may be configured to be disassembled by the end user. Hence, the inner ring 400B and the door frame 800B can be configured to have the hinges 500 mounted on either side of the door, such that the dryer door 130 can be configured to swing in a right-hand or left-hand direction. As explained below, the hinge pockets 827B for receiving the hinge 500 can be formed in both sides of the door frame 800B. The hinge 500 is secured and captured in the door frame 800B by a hinge cover or plate 550B that is secured to the door frame 800B, for example, using a plurality of screws inserted into screw points 880B of the door frame 800B. In this manner, the end user easily can change the dryer door 130, for example, from a right-hand swing door to a left-hand swing door by removing the hinge plate 550B and hinge 500, and installing the hinge 500 and hinge plate 550B in the opposite hinge pocket 827B. The hinge 500 similarly can be removed from the dryer housing and switched to the other side of the opening.

In an exemplary embodiment, the hinge pockets 427B can be 180° hinge pockets formed between the dryer frame 800B and the hinge plate 550B. The corresponding features of the dryer frame 800B and the hinge plate 550B can be conical shaped features that engage one inside the other.

FIG. 8B illustrates the rear side 430B of the inner ring 400B. The inner ring 400B can include a plurality of screw points 462B, 464B, 466B, 468B, and 470B corresponding to the screw points 862B, 864B, 866B, 868B, and 870B of the door frame 800B, which will be described in more detail below.

In this manner, the inner ring 400B and the door frame 800B can act as a single component to secure or capture the glass bowl 700B there between.

In an exemplary embodiment, the corresponding screw points of the inner ring 400A and the dryer frame 800B can be conical shaped features that engage one inside the other.

In an exemplary embodiment, the screw points 462B, 464B, 466B, 468B, and 470B can be located around a perimeter of the opening 422B of the inner ring 400B. The screw points 462B, 464B, 466B, 468B, and 470B can be located closer to the opening 422B than to the outside edge of the inner ring 400B.

The disclosed exemplary embodiments have a plurality of screw points (e.g., 462B, 464B, 466B, 468B, and 470B). However, in other exemplary embodiments, these screw points can be other types of connection points, attachments, or receptacles for receiving fasteners such as screws, bolts, plastic fasters, or the like, or for mating with other fasteners.

As explained above, the shape and size of the opening 422B can correspond to the shape and size of the glass bowl 700B of the dryer 30. The inner ring 400B can include a funnel section that extends in a direction of an axis of the opening 422B and at least partially inside the glass bowl 700B, as shown in FIG. 8C. The funnel section can include an upper portion 424B and a lower portion 426B that substantially correspond to the inner surface of the glass bowl 700B. The upper portion 424B and the lower portion 426B can be sloped or tapered in a direction of the axis of the opening 422B to correspond to the slope of the inner surface of the glass bowl 700B. In this manner, a portion of the weight of, and forces applied to, the glass bowl 700B can be transferred and distributed to the funnel section of the inner ring 400B.

In the illustrated exemplary embodiment, the upper portion 426A can be substantially circular. The lower portion 426B can extend substantially horizontally in a plane parallel to the plane of the dryer door to correspond to the shape of the glass bowl 700B. The shape of the lower portion 426B can provide clearance for a lint filter that is located below the lower portion 426B and the lower portion of the glass bowl 700B when the door is in the closed position. The lower portion 426B of the funnel can extend a predetermined distance into the glass bowl 700B to limit or block the visibility of the lint filter when the door is in the closed position. A rear edge 428B of the funnel can be tapered or curved from the upper portion 424B to the lower portion 426B, as illustrate din FIG. 8C.

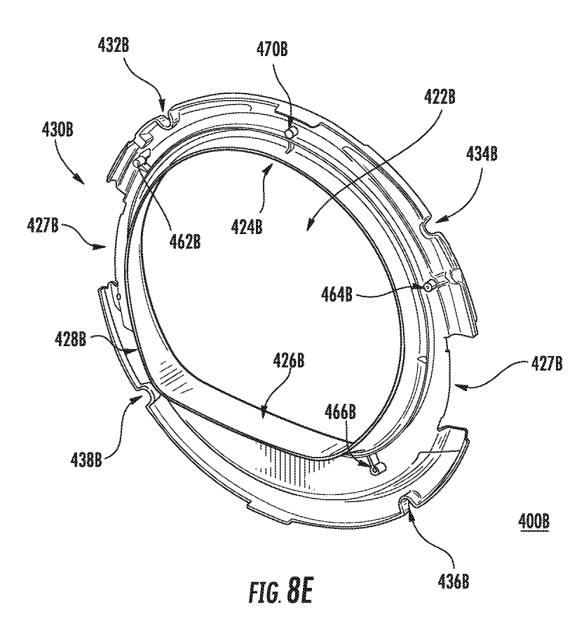

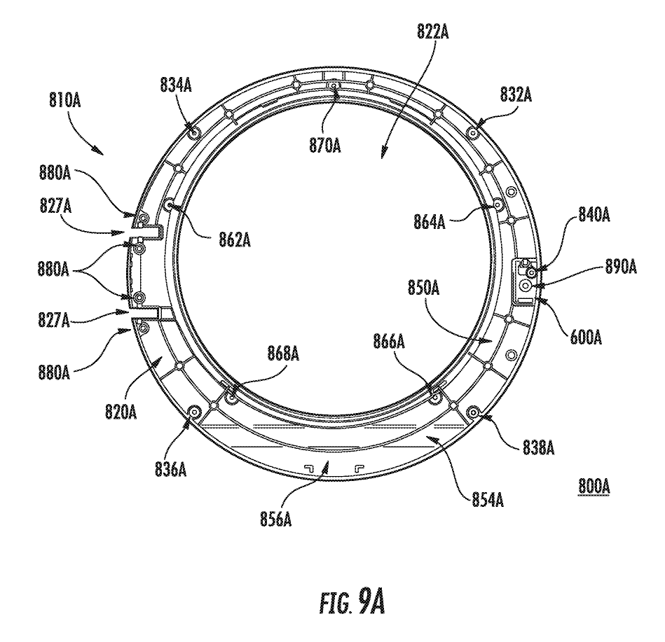

With reference to FIGS. 9A-9C, exemplary embodiments of a door frame 800A, for example for a washer 10, will now be described.

As shown in FIGS. 9A-9C, an exemplary embodiment of the door frame 800A can have a substantially circular shape when viewed from the front. However, other shapes are contemplated within the spirit and scope of the invention.

In an exemplary embodiment, the door frame 800A can be configured to have features that are particular to a washer door 100. The door frame 800A can include an opening 822A that corresponds to the see-through portion 14 of the washer door 100. The opening 822A can have, for example, a circular or oval shape, as illustrated. However, in other exemplary embodiments, the opening 822A can have other shapes.

The opening 822A can be centered (e.g., concentric) within the door frame 800A, or off-center. For example, in the exemplary embodiment illustrated, a center of the opening 822A is offset from, or above, a center of the door frame 800A such that a distance from the opening 822A to the outside edge of the door frame 800A is greater at the bottom portion of the washer door 100 than at the top portion of the washer door 100.

FIG. 9A illustrates an exemplary embodiment of the front side 810A of the door frame 800A. FIGS. 9B and 9C illustrate an exemplary embodiment of the rear side 830A of the door frame 800A.

The front side 810A of the door frame 800A can include a ring portion 820A. The rear side 830A of the door frame 800A can include a ring portion 850A.

As shown in FIGS. 9A-9C, the rear side 830A of the door frame 800A can include a tapered or sloped surface 824A leading from the surface of the ring portion 820A to a recessed surface 826A on a lower side of the door frame 800A. The tapered or sloped surface 824A and recessed surface 826A can accommodate the shape of the housing of the washer 10.

The front side 810A of the door frame 800A also can include a corresponding tapered or sloped surface 854A leading from the surface of the ring portion 850A to a recessed surface 856A on a lower side of the door frame 800A.

As shown in FIG. 9A, the front side 810A of the door frame 800A can include a rib pattern to stabilize and strengthen the door frame 800A.

In an exemplary embodiment, the features of the door frame 800A can be configured to correspond to the features of the other components of the washer door, such as the front ring 200 and inner ring 400A. As shown in FIGS. 9A-9C, the door frame 800A can include a plurality of fastener points, such as screw points 832A, 834A, 836A, and 838A, that correspond to the locations of locating and/or clearance features 332, 334, 336, and 338 of the plastic cover panel 300 and the screw points 232, 234, 236, and 238 of the front ring 200.

The screw points 832A, 834A, 836A, and 838A can include, for example, one or more protrusions, screw bosses, partial screw bosses, or through-holes or receptacles for receiving and engaging the corresponding protrusions, screw bosses, partial screw bosses of the plastic cover panel 300 and front ring 200 in an assembled position with the door frame 800A. To assemble these components, fasteners can be inserted through the screw points 832A, 834A, 836A, and 838A of the door frame, through corresponding clearance features 332, 334, 336, and 338 of the plastic cover panel 300 and into the screw points 232, 234, 236, and 238 of the front ring 200, thereby securing the front ring 200 to the door frame 800A. The plastic cover panel 300 is captured or press fit between the front ring 200 and the inner ring 400A, thereby securing the plastic cover panel 300 to the door assembly.

In an exemplary embodiment, the door frame 800A can include one or more screw points 840A that correspond to the location of clearance features 340a, 340b or 342a, 342b of the plastic cover panel 300 and the screw points 240a, and 240b of the front ring 200. These features are configured to correspond to a location of a door handle or grab handle to distribute or transfer the force applied at the handle location to the door frame 800A.

The screw points 832A, 834A, 836A, and 838A can be configured to cooperate with the features of the front ring 200 and plastic cover panel 300 such that these components only can have a single orientation for assembly. For example, one or more of the screw points 832A, 834A, 836A, and 838A can have a size different from a size of the other screw points, such that only a single orientation is possible. In this exemplary embodiment, the size of each screw point can correspond to a size of the screw points 332, 334, 336, 338, 340a, 340b, 342a, 342b of the front ring 200 and plastic cover 300. In other exemplary embodiments, the screw points can have a different shape, or a different size and shape, among other things.

In the illustrated exemplary embodiment, the screw points 834A and 838A can be larger than the other screw points to accommodate both the locating features of the front ring 200 and the locating and/or clearance features 334 and 338 of the plastic cover 300, which can include an extension. The embodiments are not limited to the illustrated exemplary embodiment and other configurations are possible within the spirit and scope of the invention.

With reference again to FIGS. 9A-9C, the door frame 800A can include a plurality of screw points 862A, 864A, 866A, 868A, and 870A that correspond to the locations of fastening points (e.g., screw points) 462A, 464A, 466A, 468A, and 470A of the inner ring 400A.

In an exemplary embodiment, the screw points 862A, 864A, 866A, 868A, and 870A can be located around a perimeter of the opening 822A of the inner ring 400A. The screw points 862A, 864A, 866A, 868A, and 870A can be located closer to the opening 822A than to the outside edge of the door frame 800A.

The disclosed exemplary embodiments of the door frame 800A have a plurality of screw points 862A, 864A, 866A, 868A, and 870A corresponding to the plurality of screw points 462A, 464A, 466A, 468A, and 470A of the inner ring 400A. However, in other exemplary embodiments, these screw points can be other types of connection points, attachments, or receptacles for receiving fasteners such as screws, bolts, plastic fasters, or the like, or for mating with other fasteners.

As explained above, the door frame 800A can include a first set of screw points 832A, 834A, 836A, and 838A that cooperate with the features of the front ring 200 and plastic cover panel 300, and a second set of screw points 862A, 864A, 866A, 868A, and 870A corresponding to the plurality of screw points 462A, 464A, 466A, 468A, and 470A of the inner ring 400A. In another exemplary embodiment, one of the first set and the second set of screw points can be recessed to reduce or eliminate possible confusion.

The door frame 800A can include hinge pockets 827A for receiving a hinge 500. In an exemplary embodiment of the washer door 10, the hinge 500 can be secured between the inner ring 400A and the washer frame 800A. In this manner, the inner ring 400A and the washer frame 800A act as a single part and the forces on the hinge 500 are transferred over both the inner ring 400A and the washer frame 800A.

Commonly, the washer door 100 may not be configured to be disassembled by the end user. Hence, the inner ring 400A and the door frame 800A can be configured to have the hinge pockets 427A and 827A on a single side of the door, such that the washer door 100 can be configured to swing in only a single direction.

In an exemplary embodiment, the hinge pockets 827A can be 180° hinge pockets formed between the inner ring 400A and the washer frame 800A. The corresponding features of the inner ring 400A and the washer frame 800A can be conical shaped features that engage one inside the other.

As shown in FIG. 9A, the door frame 800A also can include openings 880A for fastening the door frame 800A to the inner ring 400A at the location of the hinge 500.

The door frame 800A can have an opening 890A for receiving a screw boss and/or locating feature of a door hook 600A. The door frame 800A can include other features, such as one or more slots, recesses, or indentions for receiving corresponding features of the door hook 600A.

With reference to FIG. 9C, the rear side 830A of the door frame 800A will now be described.

The door frame 800A can include a plurality of screw points 862A, 864A, 866A, 868A, and 870A corresponding to the screw points 462A, 464A, 466A, 468A, and 470A of the inner ring 400A, which will be described in more detail below.

In an exemplary embodiment, the screw points 862A, 864A, 866A, 868A, and 870A can be located around a perimeter of the opening 822A of the door frame 800A. The screw points 862A, 864A, 866A, 868A, and 870A can be located closer to the opening 822A than to the outside edge of the door frame 800A. A removable ring 828A can be provided around the perimeter of the opening 822A and can include screw points corresponding to the screw points 862A, 864A, 866A, 868A, and 870A, for example, for strengthening these connections.

The disclosed exemplary embodiments have a plurality of screw points (e.g., 862A, 864A, 866A, 868A, and 870A). However, in other exemplary embodiments, these screw points can be other types of connection points, attachments, or receptacles for receiving fasteners such as screws, bolts, plastic fasters, or the like, or for mating with other fasteners.

The hinge pockets 827A are configured to receiving a hinge 500. In an exemplary embodiment of the washer door 10, the hinge 500 can be secured between the inner ring 400A and the washer frame 800A.

As shown in FIGS. 9A-9C, the door frame 800A can include a tapered or sloped surface 824A leading to a recessed surface 826A on a lower side of the door frame 800A. The tapered or sloped surface 824A and recessed surface 826A can accommodate the shape of the housing of the washer 10.

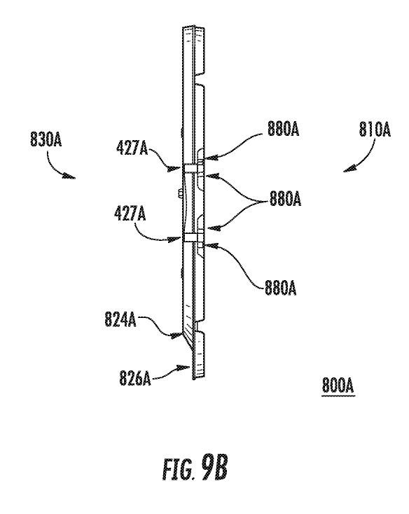

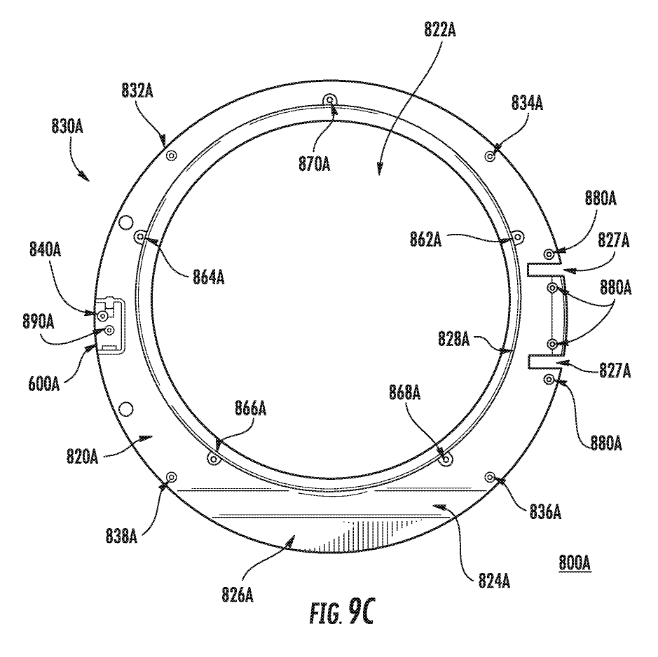

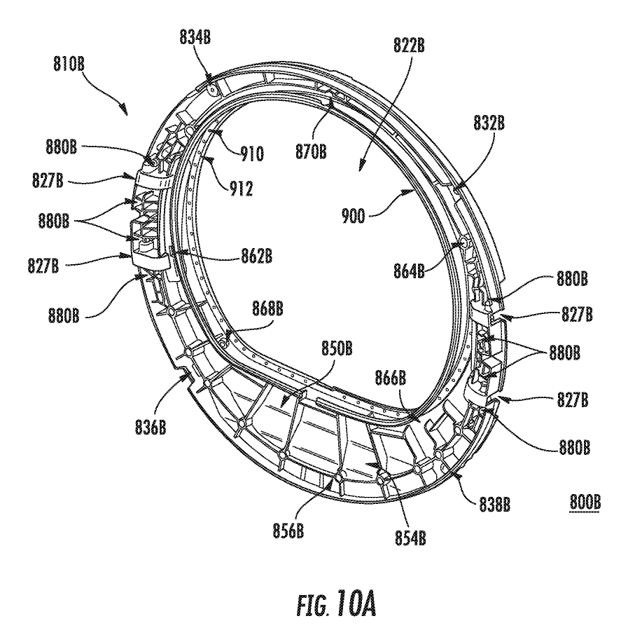

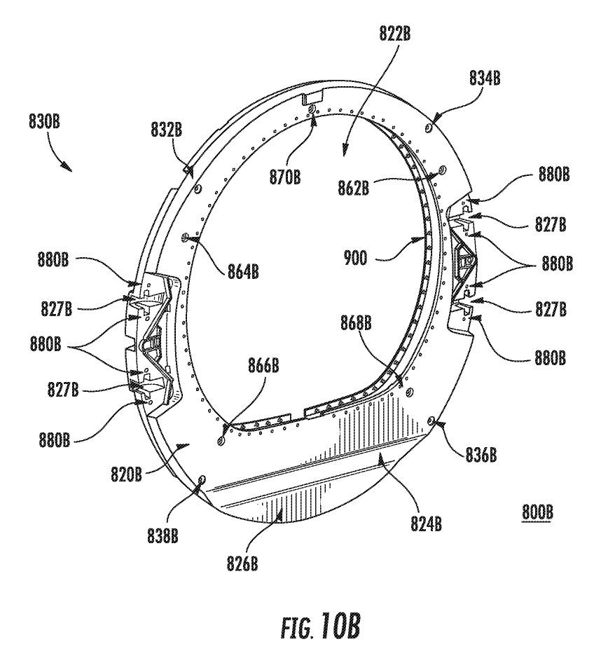

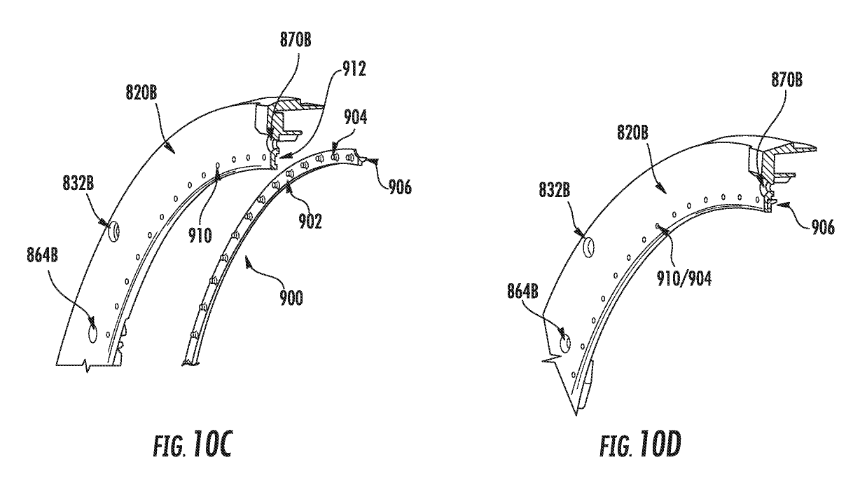

With reference to FIGS. 10A and 10B, exemplary embodiments of a door frame 800B, for example for a dryer 30, will now be described.

FIG. 10A illustrates an exemplary embodiment of the front side 810B of the door frame 800B. FIG. 10B illustrates an exemplary embodiment of the rear side 830B of the door frame 800B.

The front side 810B of the door frame 800B can include a ring portion 850B. The rear side 830B of the door frame 800B can include a ring portion 820B.

As shown in FIGS. 10B, the rear side 830B of the door frame 800B can include a tapered or sloped surface 824B leading to a recessed surface 826B on a lower side of the door frame 800B. The tapered or sloped surface 824B and recessed surface 826B can accommodate the shape of the housing of the dryer 30. That is, the portion of the housing of the dryer 30, which is adjacent to the lower side of the dryer door 130 when the door is in the closed position, can include an air flow passage and bearing shield holding the lint filter. This housing shape can be maximized to improve air flow through the lint filter. The tapered or sloped surface 824B and recessed surface 826B of the door frame 800B can accommodate this shape.

As shown in FIG. 10A, the front side 810B of the door frame 800B also can include a corresponding tapered or sloped surface 854B leading from the surface of the ring portion 850B to a recessed surface 856B on a lower side of the door frame 800B.

As shown in FIG. 10A, the front side 810B of the door frame 800B can include a rib pattern to stabilize and strengthen the door frame 800B.

In an exemplary embodiment, the features of the door frame 800B can be configured to correspond to the features of the other components of the washer door, such as the front ring 200 and inner ring 400B. As shown in FIGS. 10A and 10B, the door frame 800B can include a plurality of fastener points, such as screw points 832B, 834B, 836B, and 838B, that correspond to the locations of locating and/or clearance features 332, 334, 336, and 338 of the plastic cover panel 300 and the screw points 232, 234, 236, and 238 of the front ring 200.

The screw points 832B, 834B, 836B, and 838B can include, for example, one or more protrusions, screw bosses, partial screw bosses, or through-holes or receptacles for receiving and engaging the corresponding protrusions, screw bosses, partial screw bosses of the plastic cover panel 300 and front ring 200 in an assembled position with the door frame 800B. To assemble these components, fasteners can be inserted through the screw points 832B, 834B, 836B, and 838B of the door frame, through corresponding clearance features 332, 334, 336, and 338 of the plastic cover panel 300 and into the screw points 232, 234, 236, and 238 of the front ring 200, thereby securing the front ring 200 to the door frame 800. The plastic cover panel 300 is captured or press fit between the front ring 200 and the inner ring 400B, thereby securing the plastic cover panel 300 to the door assembly.

In an exemplary embodiment, the door frame 800B can include one or more screw points 840A that correspond to the location of clearance features 340a, 340b or 342a, 342b of the plastic cover panel 300 and the screw points 240a, and 240b of the front ring 200. These features are configured to correspond to a location of a door handle or grab handle to distribute or transfer the force applied at the handle location to the door frame 800B.

The screw points 832B, 834B, 836B, and 838B can be configured to cooperate with the features of the front ring 200 and plastic cover panel 300, thereby limiting or reducing the possible orientations of these features. For example, the plastic cover 300 can have an inner shape that permits only two possible orientations (e.g., a left-hand orientation or a right-hand orientation). Additionally, one or more of the screw points 832B, 834B, 836B, and 838B can have a size different from a size of the other screw points. The size of each screw point can correspond to a size of the screw points 332, 334, 336, 338, 340a, 340b, 342a, 342b of the front ring 200 and plastic cover 300. In other exemplary embodiments, the screw points can have a different shape, or a different size and shape, among other things.

In the illustrated exemplary embodiment, the screw points 834B and 838B can be larger than the other screw points to accommodate both the locating features of the front ring 200 and the locating and/or clearance features 334 and 338 of the plastic cover 300, which can include an extension. The embodiments are not limited to the illustrated exemplary embodiment and other configurations are possible within the spirit and scope of the invention.

With reference again to FIGS. 10A and 10B, the door frame 800B can include a plurality of screw points 862B, 864B, 866B, 868B, and 870B that correspond to the locations of fastening points (e.g., screw points) 462B, 464B, 466B, 468B, and 470B of the inner ring 400B.

In an exemplary embodiment, the screw points 862B, 864B, 866B, 868B, and 870B can be located around a perimeter of the opening 822B of the inner ring 400B. The screw points 862B, 864B, 866B, 868B, and 870B can be located closer to the opening 822B than to the outside edge of the door frame 800B.

The disclosed exemplary embodiments of the door frame 800B have a plurality of screw points 862B, 864B, 866B, 868B, and 870B corresponding to the plurality of screw points 462B, 464B, 466B, 468B, and 470B of the inner ring 400B. However, in other exemplary embodiments, these screw points can be other types of connection points, attachments, or receptacles for receiving fasteners such as screws, bolts, plastic fasters, or the like, or for mating with other fasteners.

As explained above, the door frame 800B can include a first set of screw points 832B, 834B, 836B, and 838B that cooperate with the features of the front ring 200 and plastic cover panel 300, and a second set of screw points 862B, 864B, 866B, 868B, and 870B corresponding to the plurality of screw points 462B, 464B, 466B, 468B, and 470B of the inner ring 400B. In another exemplary embodiment, one of the first set and the second set of screw points can be recessed to reduce or eliminate possible confusion.

The dryer door 130 may be configured to be disassembled by the end user. Hence, the inner ring 400B and the door frame 800B can be configured to have the hinges 500 mounted on either side of the door, such that the dryer door 130 can be configured to swing in a right-hand or left-hand direction. As explained below, the hinge pockets 827B for receiving the hinge 500 can be formed in both sides of the door frame 800B. The hinge 500 is secured and captured in the door frame 800B by a hinge cover or plate 550B that is secured to the door frame 800B, for example, using a plurality of screws inserted into screw points 880B of the door frame 800B. In this manner, the end user easily can change the dryer door 130, for example, from a right-hand swing door to a left-hand swing door by removing the hinge plate 550B and hinge 500, and installing the hinge 500 and hinge plate 550B in the opposite hinge pocket 827B. The hinge 500 similarly can be removed from the dryer housing and switched to the other side of the opening.

In an exemplary embodiment, the hinge pockets 427B can be 180° hinge pockets formed between the dryer frame 800B and the hinge plate 550B. The corresponding features of the dryer frame 800B and the hinge plate 550B can be conical shaped features that engage one inside the other.

The dryer door 130 may be configured to be disassembled by the end user. Hence, the inner ring 400B and the door frame 800B can be configured to have the hinges 500 mounted on either side of the door, such that the dryer door 130 can be configured to swing in a right-hand or left-hand direction. As explained below, the hinge pockets 827B for receiving the hinge 500 can be formed in both sides of the door frame 800B. The hinge 500 is secured and captured in the door frame 800B by a hinge cover or plate 550B that is secured to the door frame 800B, for example, using a plurality of screws inserted into screw points 880B of the door frame 800B. In this manner, the end user easily can change the dryer door 130, for example, from a right-hand swing door to a left-hand swing door by removing the hinge plate 550B and hinge 500, and installing the hinge 500 and hinge plate 550B in the opposite hinge pocket 827B. The hinge 500 similarly can be removed from the dryer housing and switched to the other side of the opening.

In an exemplary embodiment, the hinge pockets 427B can be 180° hinge pockets formed between the dryer frame 800B and the hinge plate 550B. The corresponding features of the dryer frame 800B and the hinge plate 550B can be conical shaped features that engage one inside the other.

FIG. 10B illustrates the rear side 830B of the door frame 800B. The door frame 800B can include a plurality of screw points 862B, 864B, 866B, 868B, and 870B corresponding to the screw points 462B, 464B, 466B, 468B, and 470B of the inner ring 400B.

In this manner, the inner ring 400B and the door frame 800B can act as a single component to secure or capture the glass bowl 700B there between.

In an exemplary embodiment, the corresponding screw points of the inner ring 400B and the dryer frame 800B can be conical shaped features that engage one inside the other.

As shown in FIG. 10A, the door frame 800B also can include openings 880B for fastening the door frame 800B to the inner ring 400B at the location of the hinge 500.

The door frame 800B can have an opening 890B for receiving a screw boss and/or locating feature of a door striker 600B. The door frame 800B can include other features, such as one or more slots, recesses, or indentions for receiving corresponding features of the door striker 600B.

With reference to FIG. 10B, the rear side 830B of the door frame 800B will now be described.

The door frame 800B can include a plurality of screw points 862B, 864B, 866B, 868B, and 870B corresponding to the screw points 462B, 464B, 466B, 468B, and 470B of the inner ring 400B.

In an exemplary embodiment, the screw points 862B, 864B, 866B, 868B, and 870B can be located around a perimeter of the opening 422B of the inner ring 400B. The screw points 862B, 864B, 866B, 868B, and 870B can be located closer to the opening 422B than to the outside edge of the inner ring 400B.

The disclosed exemplary embodiments have a plurality of screw points (e.g., 862B, 864B, 866B, 868B, and 870B). However, in other exemplary embodiments, these screw points can be other types of connection points, attachments, or receptacles for receiving fasteners such as screws, bolts, plastic fasters, or the like, or for mating with other fasteners.

The door frame 800B can include hinge pockets 827B configured to receive a hinge 500. The hinge pockets 827B can be formed in the rear side 830B of the door frame 800B and on each of a first side and a second side of the door frame, as illustrated in FIG. 10B.

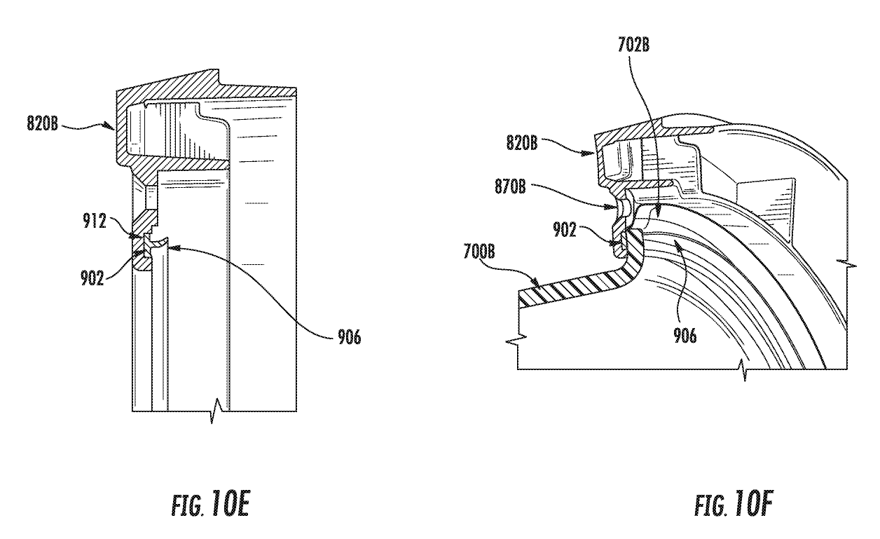

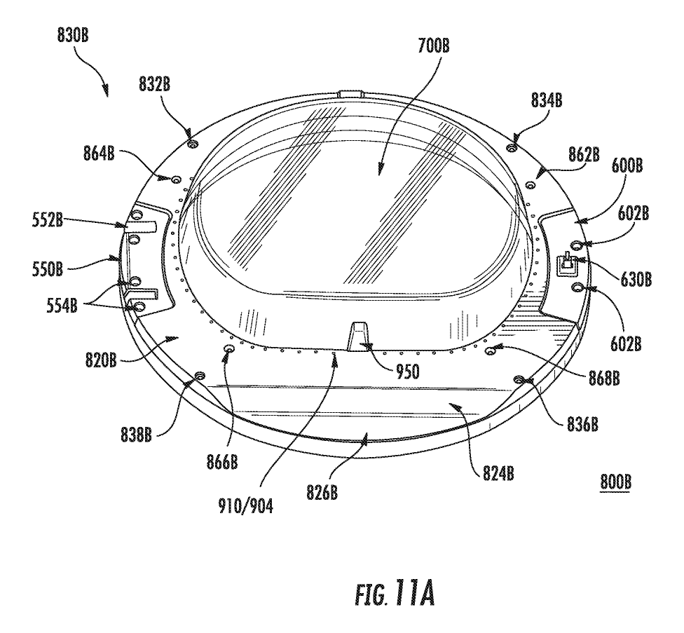

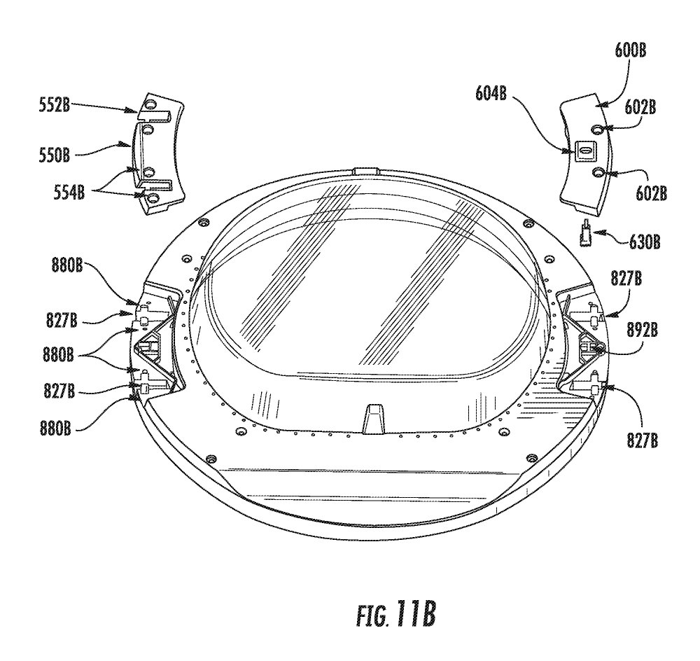

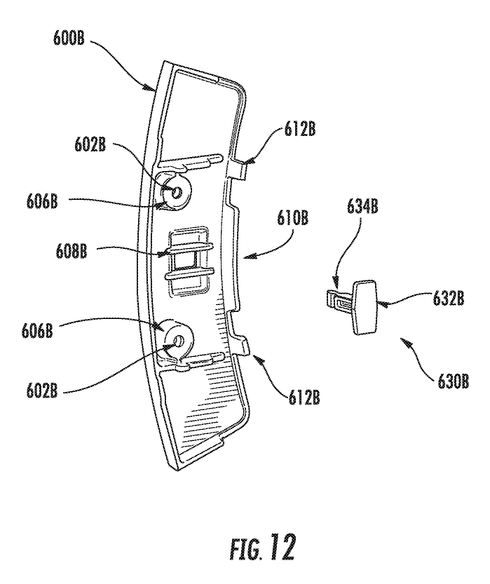

As shown in FIGS. 11A, 11B, and 12, a hinge plate 550B can be provided to removably engage one of the hinge pockets 827B. A hinge 500 can be captured between the hinge pocket 827B and the hinge plate 550B.

In another exemplary embodiment, a striker plate 600B can be provided to removably engage and cover the other hinge pocket 827B on the second side. A removable door striker 630B can be captured between the hinge pocket 827B and the striker plate 600B. The removable door striker 630B can engage a corresponding feature on the housing of the dryer 30 to secure the dryer door 130 in a closed position.

As shown in FIG. 12, the door striker 630B can include a base portion 632B and a projection 634B. The striker plate 600B can include an opening 608B. The projection 634B of the door striker 630B can be inserted through the opening 608B of the striker plate 600B such that the projection 634B extends through the opening 608B to an exterior of hinge pocket 827B for engaging a striker receptacle formed in the housing of the dryer 30.

In an exemplary embodiment, the striker plate 600B only can be inserted into the opening 608B in a single position or orientation, thereby ensuring a proper assembly. In another exemplary embodiment, the striker plate 600B can include a positioning feature, such as one or more ribs or recessed, for positioning the base portion 632B of the door striker 630B in a desired position.

The hinge plate 550B and the striker plate 600B can be interchangeable between each of the hinge pockets 827B, thereby allowing the hinge and striker locations to be switched easily from one side of the dryer door 130 to the other. In this manner, the dryer door 130 can be changed easily from a right-hand swing door to a left-hand swing door, and vice versa.

With reference again to FIGS. 10A-13C, the glass bowl 700B can be captured and secured between the inner ring 400B and the door frame 800B. A rim 702B of the glass bowl 700B can be sealed against a surface of the door frame 800B adjacent to the opening 822B.

As shown in FIGS. 10A to 10F, the inside edge of the door frame 800B, which defines the opening 822B, can include an overmold seal 900 that seals the rim 702B of the glass bowl 700B against the door frame 800B. For illustrative purposes, the overmold seal 900 is illustrated with respect to the dryer door 130.

In an exemplary embodiment, the door frame 800B can be formed (e.g., by injection molding) with a plurality of openings 910 around the inside edge, and then allowed to cool. In other exemplary embodiments, the openings 910 can be formed in the door frame 800B after the door frame 800B is formed. In the illustrated exemplary embodiment, the openings 910 can extend through the door frame 800B. In other exemplary embodiments, the opening 910 can extend partially through the door frame 800B on the front side 810B of the door frame 800B.

Next, the door frame 800B can be placed in an injection molding machine, for example, that sandwiches the door frame 800B between two molding plates. Another injection molding process can then be performed to form the overmold seal 900 around the edge of the door frame 800B and only on the front side 810B. In this manner, a plurality of portions 902 of the overmold seal 900 can be injected into the openings 910 of the door frame 800B such that the overmold seal 900 can mechanically engage the door frame 800B.

A base portion 902 of the overmold seal 900 can be formed against a surface of the front side 810B of the door frame 800B along the perimeter of the opening 822B. An exemplary embodiment of the overmold seal 900 can be integrally formed with a lip 906 projecting from the base portion 902 and extending around the opening 822B of the door frame 800B.

In an exemplary embodiment, a recessed portion 912, such as a recess, groove, or track, can be provided in the surface of the front side 810B of the door frame 800B and extending around the opening 822B. The base portion 902 of the overmold seal 900 can be formed in the recessed portion 912 such that the base portion 902 is flush with an adjacent area of the door frame 800B. In this manner, the mechanical engagement between the overmold seal 900 and the door frame 800B can be further strengthened. Moreover, only the lip 906 of the overmold seal 906 extends from the surface of the door frame 800B.

As shown in FIG. 10F, the glass bowl 700B can be captured and secured between the door frame 800B and the inner ring 400B such that the rim 702B of the glass bowl 700B is pressed against the lip 906 of the overmold seal 900, thereby sealing the rim 702B of the glass bowl 700B to the door frame 800B.

In this manner, the exemplary embodiments of the present invention can provide an appliance door having an overmold seal that is molded only on a single side of the edge of the door frame that defines the opening in the door frame. The overmold seal can be formed by injection molding the seal on the door frame. In this manner, the exemplary embodiments can reduce the assembly time and labor costs associated with the manufacture and assembly of the appliance door. Additionally, the exemplary embodiments can reduce the material costs associated with each appliance door.

Moreover, the exemplary embodiments can mechanically seal the overmold seal to the inside edge of the door frame, thereby improving the reliability and dependability of the seal between the door frame and the glass bowl.

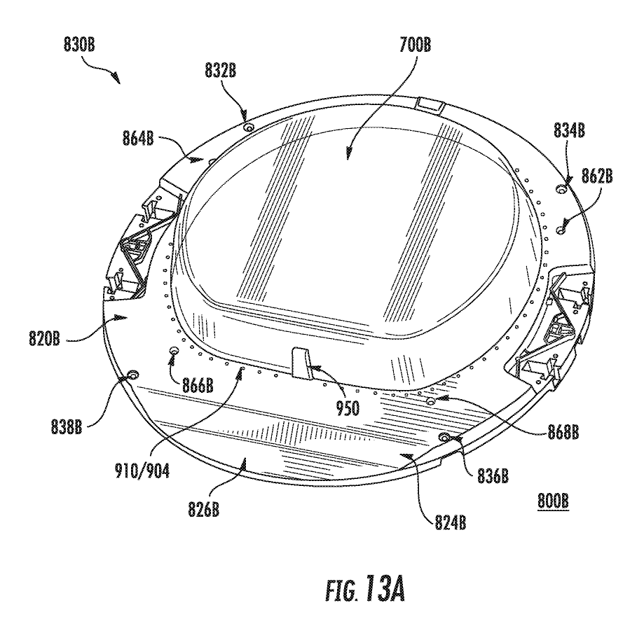

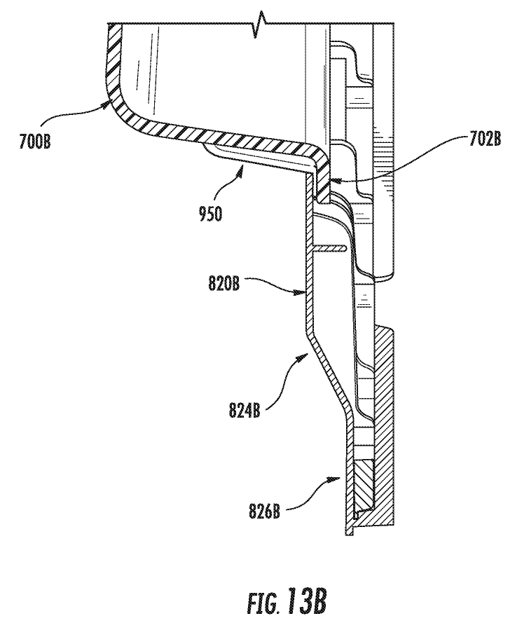

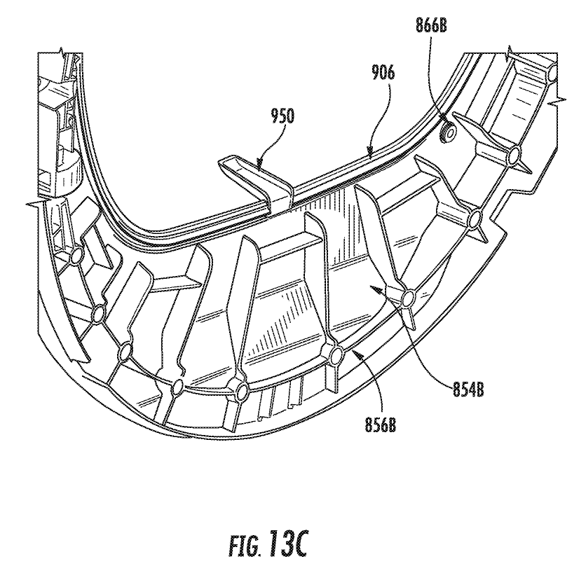

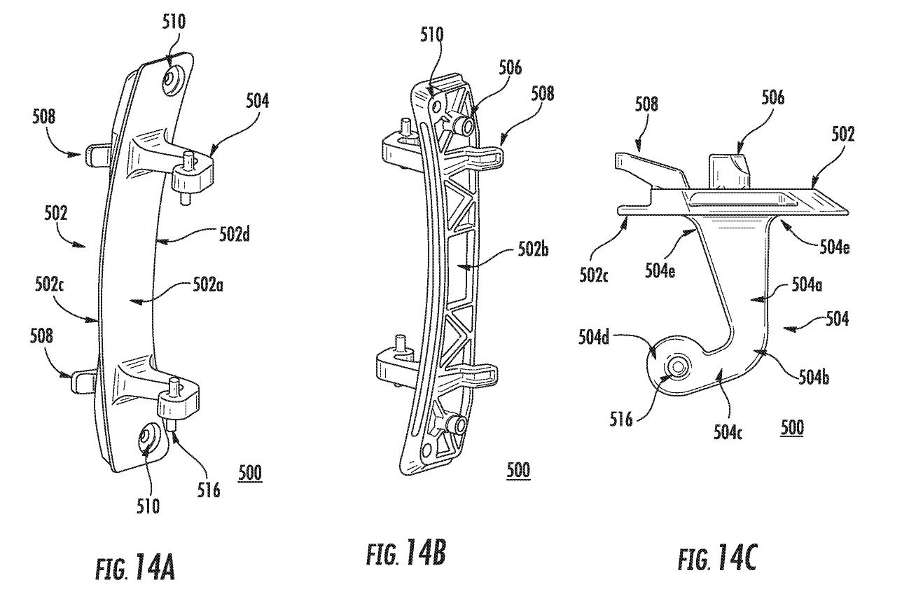

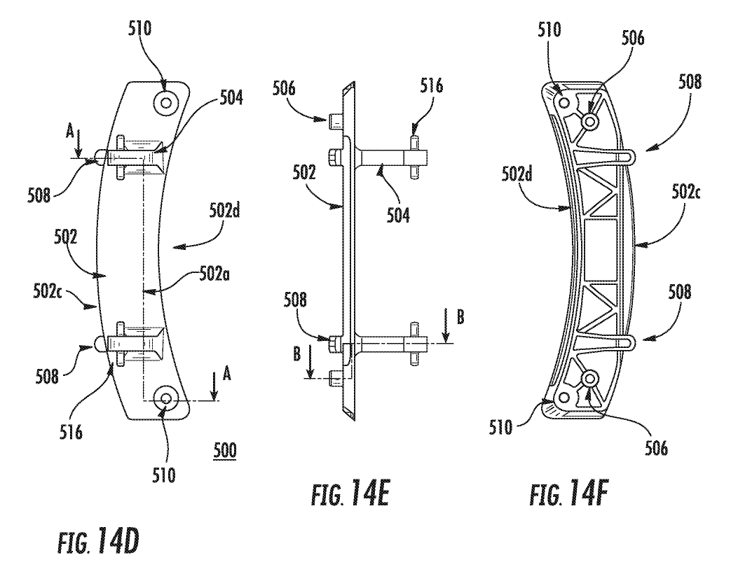

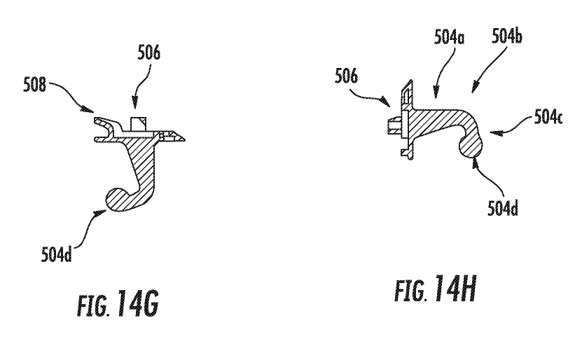

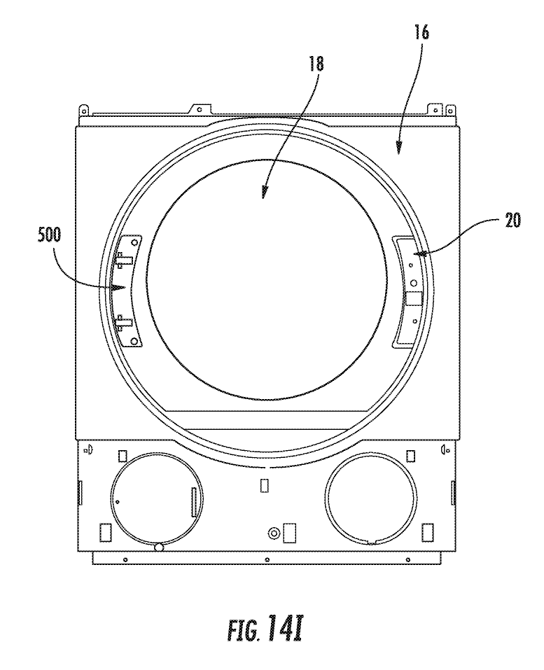

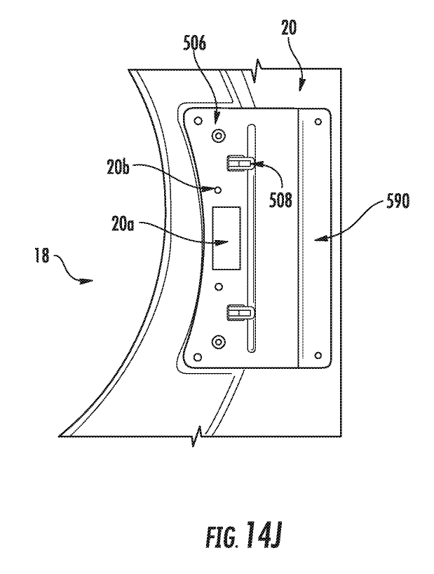

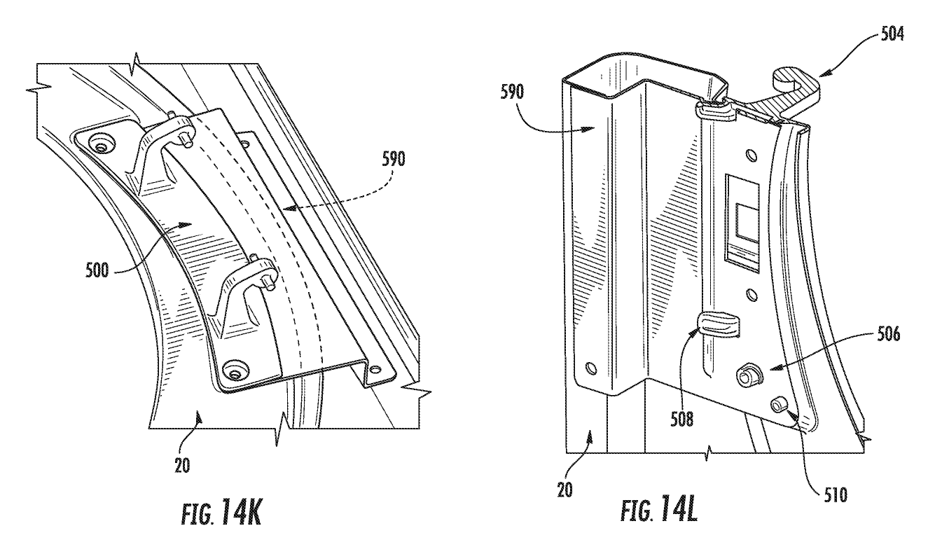

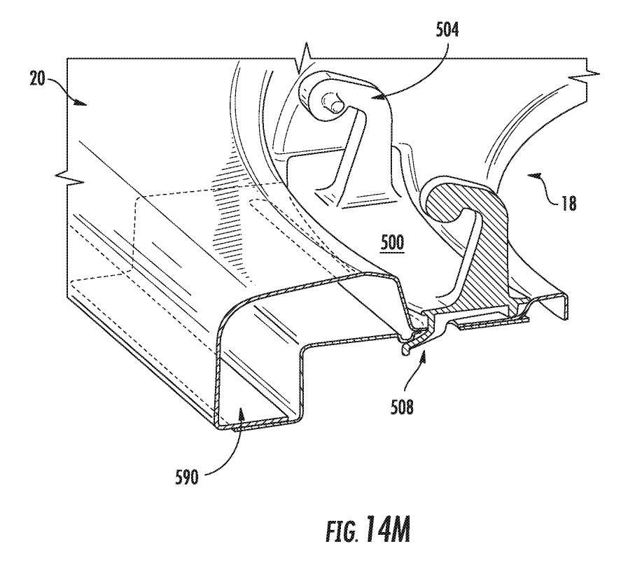

With reference to FIGS. 13A-14, an exemplary embodiment of a door ramp 950 will now be described.

In operation, the appliance door, such as the dryer door 130, can be pivoted about the hinge 500 from an open position to a closed position covering the opening of the appliance housing, such as housing 32. In some cases, the appliance door may not be perfectly aligned with the opening in the housing 32, or the appliance door may sag over time. For example, the appliance door (e.g., dryer door 130) may sag as a result of external forces being applied to the door, such as a user leaning on the door, or as a result of the weight of the door itself acting on the connection between the hinge 500 and the housing 32. This sagging may result in the door striker not being aligned properly for closing the door. To solve these problems, an exemplary embodiment can include a ramp 950 to assist with the alignment of the door 130 with the opening of the housing 32.

As shown in FIGS. 13A and 13B, the ramp 950 can be compression fit between a lower portion of the inside edge of the door frame 800B and the glass bowl 700B. The ramp 950 projects from the door frame 800B in a direction of the axis of the opening 822B of the door frame 800B and along the underside of the lower surface of the glass bowl 700B.

In an exemplary embodiment, the overmold seal 900 can be notched or cut to receive the ramp 950, as shown in FIG. 13C. In other exemplary embodiments, the ramp 950 can be secured to the door frame 800B by a fastening device, such as a slot and tab.

As shown in FIG. 14, an exemplary embodiment of the ramp 950 can have a generally L-shaped profile. The ramp 950 can include a base portion 952 forming a first leg of the L-shaped profile, a cam portion 954 forming a second leg of the L-shaped profile, and a closed end 956.

The base portion 952 of the ramp 950 can include a face 958 that is configured to press fit against a surface of the rim of the glass bowl 700B when the door is assembled. In another exemplary embodiment, the base portion 952 can include a sealing feature. An opposite side of the base portion 952 can be press fit against the front side 810B of the door frame 800B.

The cam portion 954 of the ramp 950 can include a cam plate 964 having sidewalls 960 and an end wall 962.

The sidewalls 960 can include upper surfaces 966 that can engage a lower surface of the glass bowl 700B. Similarly, the closed end 956 can include an upper surface 968 that can engage the lower surface of the glass bowl.

In operation, as the dryer door 130 is being moved to the closed position, the lower surface of the cam plate 964 of the cam portion 954 of the ramp 950 can engage a portion of the opening of the housing 32 and lift the door into proper alignment with the opening of the housing 32, and into proper alignment for the striker to engage the striker receptacle on the housing.

The exemplary embodiments are not limited to this arrangement and the ramp 950 can have other profiles, such as a triangular or rectangular profile, within the spirit and scope of the invention. In this exemplary embodiment, the cam portion 954 is longer than the base portion 952. However, the cam portion 954 and base portion 952 can be the same or other sizes. In the illustrated exemplary embodiment, the ramp 950 is hollow, for example, to reduce material and weight. However, in other exemplary embodiments, the ramp 950 can be a solid ramp or plate having a cam surface, or the like. The cam surface can be a sloped surface or a curved surface.

In the disclosed exemplary embodiments, the ramp 950 is formed separately from the door fame 800B. In other exemplary embodiments, the ramp 950 can be integrally formed with the door frame 800B, for example, during the injection molding process of the door frame 800B. In another exemplary embodiment, the ramp 950 can be integrally formed with the overmold seal 900, for example, during the injection molding process of the overmold seal 900, or in an earlier or subsequent injection molding process.

With reference to FIGS. 14A-14M, exemplary embodiments of a universal door hinge 500 will now be described.

The exemplary embodiments provide a universal door hinge 500 that can be used for both a washer door 100 and a dryer door 130. The hinge 500 can provide 180 of rotation of the washer door 100 or dryer door 130.

The hinge 500 can include a hinge body 502 configured to be mounted to the front panel 16 of the housing 12, 32 of a washer 10 or dryer 30, respectively. The hinge 500 includes a pair of hinge arms 504 extending from a front surface 502a of the hinge body 502. The hinge arms 504 are configured to provide 180° of rotation of the washer door 100 or dryer door 130 in an assembled position.

The hinge 500 can include one or more locating bosses 506 projecting from a rear surface of the hinge body 502. The locating bosses 506 can ensure proper and accurate alignment of the hinge 500 in the cutout or stamping 20 of the front panel 16 of the housing 12, 32. In an exemplary embodiment, the locating bosses 506 can provide accurate alignment up to, for example, 0.1 mm.

In an exemplary embodiment, the hinge body 502 can include one or more curved edges 502c, 502d that correspond to a shape of a cutout or stamping 20 on the housing of the washer or dryer such that the hinge can be installed only in a single configuration for a left-hand opening door and a single configuration for a right-hand opening door.

An exemplary embodiment of the hinge 500 includes a pair of hooks 508 extending from a rear surface 502b of the hinge body 502, thereby addressing forces exerted on the hinge 500 in a first horizontal direction. The pair of hooks 508 can be aligned with the hinge arms 504, thereby transferring the force on the hinge arms 504 to the front panel 16 of the housing 12, 32.

An exemplary embodiment of the hinge 500 also includes a pair of screw points 510 extending through the hinge body 502 that can address forces exerted on the hinge 500 in a second horizontal direction. The pair of screws points 510 can be configured to be spaced at far ends of the hinge body 502 (e.g., as far apart as possible), thereby reducing or limiting deformation caused by the twisting forces (e.g., twisting or torque) induced by the door on the hinge. The pair of screws points 510 also can distribute the force applied to the screws (not shown) over a larger area of the front panel 16 of the housing 12, 32.

As shown in FIGS. 14D- 14F, the pair of screw points 510 for securing the hinge 500 to the front panel 16 of the housing 32 of the dryer 30 can be offset from the hinge arms 504. In this manner, the screw points 510 can be easily accessed for attaching or removing the hinge 500 from the front panel 20 of the housing 32 of the dryer 30 irrespective of whether the hinge 500 is assembled with the dryer door 130 or disassembled from the dryer door 30, thereby permitting the user to easily change the dryer door 130 from a right-hand swing door to a left-hand swing door, and vice versa.

In an exemplary embodiment, the hinge arms 504 can have an increased thickness, and more particularly, an increased thickness closer to the hinge body 502 for increasing a stiffness of the hinge 500, thereby avoiding or reducing sagging over time as a result of the forces exerted on the hinge 500, for example, when the door 100, 130 is in the open position, or in the event a user leans on the open door, etc. These features are important since a small amount of sagging the hinge can result in a large amount of sagging at the door striker, thereby affecting the operation of the opening and closing of the door. For example, 1 mm of sagging at the hinge may result in a misalignment of the door striker of 3 mm or more, thereby affecting the latching and locking of the door.

With reference to FIGS. 14C, 14G, and 14H, an exemplary embodiment of the hinge arm 504 includes a first portion 504a, a second elbow portion 504b, a third portion 504c, and an end portion 504d. The hinge arm 504 can include a chamfered portion 504e connecting the first portion 504a to the front surface 502a of the hinge body 502. The hinge arm 504 can have a substantially L-shaped configuration when viewed from a side. The thickness of the first portion 504a closer to the front surface 502a of the hinge body 502 can be greater than a thickness of the first portion 504a closer to the second elbow portion 502b of the hinge body 502. The end portion 504d has a dowel 516 extending from each side of the end portion 504d for engaging the hinge pockets of the door 100, 130, as described below.

With reference to FIGS. 14H-14L, the housing 12, 32 of the washer 10 or dryer 30 can include a front panel 16 having an opening 18 for accessing the rotating drum in the interior of the housing 12, 32. The front panel 16 of the housing 12, 32 can have a hinge mounting surface (e.g., a cutout or stamping 20) configured to receive a hinge 500 for pivoting the door 100, 130 with respect to the washer 10 or dryer 30.

The hinge mounting surface can be located along the perimeter of the opening 18. The front panel can include hinge mounting surfaces (e.g., cutouts or stampings 20) on either side of the opening 18 in a mirror image, thereby facilitating changing the swing of the door 130 between a left-hand opening door and a right-hand opening door by the user, particularly in the case of a dryer 30. For example, the hinge mounting surfaces can be located on opposite sides of the opening 18.

During assembly, the hinge 500 can be simply and easily inserted in a horizontal direction into a controlled cutout and stamping 20 on the front panel 16 of the housing 12, 32 and rotated into a flush position on the front panel 16, thereby simplifying the assembly process, reducing time and labor costs, and reducing overall manufacturing costs. In the case of changing the swing of the door 130 between a left-hand opening door and a right-hand opening door by the user, particularly in the case of a dryer 30, the hinge 500 can simply be rotated 180° and inserted horizontally into the opposite hinge mounting surface.

For example, the hooks 508 can be inserted into corresponding cutouts in the front panel 16. The rear surface 502b of the hinge body 502 can be rotated toward the front panel 16 until the locating bosses 506 engage corresponding locating holes formed in the front panel. The hinge 500 then can be secured to the front panel 16 using screws (not shown) inserted through the screw points 510 and into corresponding screw points formed in the front panel 16.

As illustrated in FIGS. 14I-14L, a hinge plate 590 can be provided on the rear side of the front panel 16. The hinge plate 590 can strengthen the connection between the hinge 500 and the front panel 16 of the housing 12, 32. In this exemplary embodiment, the hinge plate 590 can include cutouts corresponding to the cutouts in the front panel for the hooks 508 and/or the locating bosses 506. The hinge plate 590 also can include screw points corresponding to the screw points of the front panel 16 for receiving the screws inserted through the screw points 510 of the hinge 500.

According to the exemplary embodiments of the invention, the hinge 500 can be assembled with the washer door prior to installation on the housing of the washer. The hinge 500 also can be easily removed from the housing of the washer, for example, for repairs or maintenance.

In the case of the dryer door 130, the hinge 500 can be assembled with the dryer door 130 prior to installation on the housing 32 of the dryer 30. Alternatively, the hinge can be assembled on the housing 32 of the dryer 30 prior to assembly with the dryer door 130.

According to an exemplary embodiment of the present invention, in a case in which a user wishes to change the swing of the dryer door 130, the disassembly and re-assembly of the appliance door can be easily and efficiently performed in a time effective manner by technicians or end-users, for example, since the entire door does not need to be disassembled and re-assembled in order to make such a change, and since the hinge 500 is easily removed from the dryer housing 30 without or without removing the hinge 500 from the dryer door 130.

With reference again to FIGS. 11A and 11B, in another exemplary embodiment of the invention, the universal hinge 500 can be captured in a hinge pocket 827B formed in the door frame 800B, for example, for a dryer door 130. The hinge 500 can be secured in the hinge pocket 827B using a hinge cover 600B to facilitate easy assembly and disassembly by a user, thereby facilitating easy changing of the door 130 from a left-hand swing door to a right-hand swing door, and vice versa.

With reference again to FIGS. 7A to 7C and 9A to 9C, in another exemplary embodiment of the invention, the universal hinge 500 can be captured in a hinge pocket 427A, 827A formed between cooperating features of an inner ring 400A and a door frame 800A of the door assembly, for example, for a washer door 100. In this manner, the present invention transfers or distributes the forces acting on the hinge 500 over two parts of the door assembly (e.g., the inner ring 400A and the door frame 800A), which act as one integral component, thereby providing a robust door assembly design. The cooperating features of an inner ring 400A and a door frame 800A can be conical shaped features that engage on inside the other.

The exemplary embodiments provide universal door hinge 500 that can be used for both a washer door 100 and a dryer door 130. The door hinge 500 has a compact, clean, and elegant design while also providing robust features for addressing a variety of forces exerted on the hinge 500 during operation of the washer door 100 or dryer door 130.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

What is claimed is:

1. A hinge for a door assembly of a household appliance, wherein the household appliance includes a housing having an opening for accessing an interior of the housing, a tub disposed inside the housing, the tub having a rotating drum therein for receiving laundry through the opening, the door assembly having a see-through portion for viewing into the tub, the door assembly being pivotably coupled to the housing by the hinge and movable between an open position for accessing the opening of the housing and a closed position for closing the opening of the housing, wherein the hinge comprises:
a hinge body configured to be mounted to a front panel of the housing;
a pair of hinge arms extending from a front surface of the hinge body;
a locating boss projecting from a rear surface of the hinge body;
a pair of hooks extending from the rear surface of the hinge body; and
a pair of screw points extending through the hinge body.

2. The hinge of claim 1, wherein the hinge is universal to a washer door and a dryer door.

3. The hinge of claim 1, wherein the locating boss comprises a pair of locating bosses adjacent to opposite ends of the hinge body.

4. The hinge of claim 1, wherein the hinge body includes a curved edge that corresponds to a shape of a stamping on the front panel of the housing such that the hinge can be installed only in a single configuration for a left-hand opening door and a single configuration for a right-hand opening door.

5. The hinge of claim 1, wherein the pair of hooks is aligned with the hinge arms.

6. The hinge of claim 1, wherein each of the pair of screws points is spaced apart from each other at far ends of the hinge body.

7. The hinge of claim 1, wherein each of the pair of screws points is offset from the hinge arms in a direction toward the pair of hooks.

8. The hinge of claim 1, wherein a thickness of each of the pair of hinge arms closer to the hinge body is greater than a thickness of each of the pair of hinge arms farther from the hinge body.

9. The hinge of claim 1, wherein each of the pair of hinge arms includes:
a first portion adjacent to the hinge body;
a second elbow portion following the first portion;
a third portion following the second elbow portion; and
an end portion following the third portion.

10. The hinge of claim 9, comprising a chamfer portion coupling the first portion of the hinge arm to the front surface of the hinge body.

11. The hinge of claim 1, wherein each of the hinge arms has a substantially L-shaped configuration when viewed from a side.

12. The hinge of claim 9, wherein the end portion of each of the hinge arms includes a pair of dowels, each extending from sides of the end portion.

13. The hinge of claim 1, wherein the household appliance is a washer.

14. The hinge of claim 1, wherein the household appliance is a dryer.

15. A household appliance comprising:
a housing having an opening for accessing an interior of the housing;
a tub disposed inside the housing, the tub having a rotating drum therein for receiving laundry through the opening; and
a door assembly having a see-through portion for viewing into the tub, the door assembly being pivotably coupled to the housing and movable between an open position for accessing the opening of the housing and a closed position for closing the opening of the housing,
wherein the door assembly includes:
a hinge that pivotably couples the door assembly to the housing, wherein the hinge includes:
a hinge body configured to be mounted to a front panel of the housing;
a pair of hinge arms extending from a front surface of the hinge body;
a locating boss projecting from a rear surface of the hinge body;
a pair of hooks extending from the rear surface of the hinge body; and
a pair of screw points extending through the hinge body.

16. The household appliance of claim 15, wherein the household appliance is a washer.

17. The household appliance of claim 15, wherein the household appliance is a dryer.

18. The household appliance of claim 15, wherein the door assembly includes a door frame including a pair of hinge pockets, and
wherein the pair of hinge arms are pivotably mounted in the pair of hinge pockets.

19. The household appliance of claim 18,
wherein the door assembly includes a hinge cover coupled to the door frame over the pair of hinge pockets, and
wherein the pair of hinge arms is secured in the pair of hinge pockets of the door frame by the hinge cover.

20. The household appliance of claim 15, wherein the door assembly includes:
an inner ring; and
a door frame coupled to the inner ring,
wherein each of the inner ring and the door frame include a pair of hinge pockets that cooperate to pivotably secure the pair of hinge arms between the inner ring and the door frame.

21. The household appliance of claim 15, wherein the door assembly includes:
an inner ring; and
a door frame coupled to the inner ring,
wherein one of the inner ring and the door frame include a pair of hinge pockets, and
wherein the pair of hinge arms are pivotably mounted in the pair of hinge pockets.

22. The household appliance of claim 21, wherein an end portion of each of the pair of hinge arms includes a pair of dowels, each extending from sides of the end portion, and
wherein each of the pair of dowels engages each of the pair of hinge pockets.

23. The household appliance of claim 22,
wherein the door frame includes the pair of hinge pockets,
wherein the door assembly includes a hinge cover coupled to the door frame over the pair of hinge pockets, and
wherein each of the pair of dowels of the pair of hinge arms is secured in each corresponding pair of hinge pockets of the door frame by the hinge cover.

24. The household appliance of claim 22,
wherein a pair of corresponding features on the inner ring and the door frame cooperate to form the pair of hinge pockets, and
wherein each of the pair of dowels of the pair of hinge arms is secured in the corresponding pair of hinge pockets between the door frame and the inner ring.

25. The household appliance of claim 15, wherein the housing comprises:
the front panel including:
a first cutout that receives the locating boss projecting from the rear surface of the hinge body;
a pair of second cutouts that receive the pair of hooks extending from the rear surface of the hinge body; and
a pair of second screw points corresponding to the pair of screw points of the hinge body.

26. The household appliance of claim 25, comprising:
a hinge plate mounted to a rear surface of the front panel,
the hinge plate including:
a third cutout that receives the locating boss projecting from the rear surface of the hinge body;
a pair of fourth cutouts that receive the pair of hooks extending from the rear surface of the hinge body; and
a pair of third screw points corresponding to the pair of screw points of the hinge body.

27. The household appliance of claim 25, wherein the front panel of the housing comprises:
a stamped portion corresponding to a shape of the rear surface of the hinge body,
wherein the hinge body is mounted in the stamped portion.

28. The household appliance of claim 27, wherein the front surface of the hinge body is substantially flush with the front panel.

29. The household appliance of claim 27, wherein the front panel of the housing comprises a pair of stamped portions, each of the pair of stamped portions formed on an opposite side of the opening of the housing.

30. A door assembly of a household appliance, wherein the household appliance includes a housing having an opening for accessing an interior of the housing, a tub disposed inside the housing, the tub having a rotating drum therein for receiving laundry through the opening, the door assembly having a see-through portion for viewing into the tub, the door assembly being pivotably coupled to the housing and movable between an open position for accessing the opening of the housing and a closed position for closing the opening of the housing, wherein the door assembly comprises:
a hinge that pivotably couples the door assembly to the housing,
wherein the hinge includes:
a hinge body configured to be mounted to a front panel of the housing;
a pair of hinge arms extending from a front surface of the hinge body;
a locating boss projecting from a rear surface of the hinge body;
a pair of hooks extending from the rear surface of the hinge body; and
a pair of screw points extending through the hinge body.

31. The door assembly of claim 30, wherein the household appliance is a washer.

32. The door assembly of claim 31, wherein the household appliance is a dryer.
